(19) United States
(12) Patent Application Publication
(10) Pub. No.: US 2022/0243684 A1
(43) Pub. Date: Aug. 4, 2022

(54) PROPULSION CONCEPT COMBINING CONVENTIONAL ROCKET ENGINES AND AIR-BREATHING ENGINES (HEBER CONCEPT)

(71) Applicant: Mathias Hermann, Erfurt (DE)

(72) Inventor: Mathias Herrmann, Erfurt (DE)

(21) Appl. No.: 17/492,587

(22) Filed: Apr. 20, 2022

(30) Foreign Application Priority Data
Oct. 7, 2020 (DE) DE102020006254.7

(51) Int. Cl. F02K 7/10

(52) U.S. Cl. CPC F02K 7/10

(57) ABSTRACT

A system for vertical or inclined take-offs of air-breathing engine systems comprising: an additional guidance system for the air-breathing engine system, which can selectively supply additional inflowing atmosphere or air. A control system capable of selectively supplying the additional incoming atmosphere in a variable manner to the air-breathing engine system. Additional inflowing atmosphere air can be supplied by thrust, from a conventional rocket engine system or the air-breathing engine system. Volumetric base structure pneumatic or hydraulic press-on body and flexible deck structure as variable or partially variable in shape or position for air-breathing thruster system, guidance system, control system. Variable diffusers, bypasses, exhausters, open spaces, junctions of mass flows of the additional incoming atmosphere at the additional guidance system or in the engine to specifically prevent scavenging or stalls. Additional mobile feed of an oxidizer carried along for starting purposes or for support during operation.

### CROSS REFERENCE TO RELATED DOCUMENTS

The present application claims priority to provisional patent application number DE 10 2020 006 254.7 filed on Oct. 7, 2020 in Germany, disclosure of which are intercorporated herein at least by reference.
no patent literature:
   [1] Reinhard Midler (reference book): Luftstrahltriebwerke—Grundlagen, Charakteristiken Arbeitsverhalten, ISBN 978-3-322-90325-9; Vieweg & Sohn Verlagsgesellschaft; 1997
   [2] Wilfried Ley et. Al. (reference book): Handbuch der Raumfahrttechnik; 5th revised edition; ISBN: 978-3-446-45429-3; Carl Hanser Verlag Munchen; 2019
   [3] https://de.wikipedia.org/wiki/Merlin_(Raketentriebwerk)
   [4] https://www.nasa.gov/pdf/64281main_DRC-010-039_Ram-Booster.pdf
   [5] https://www.reactionengines.co.uk
   [6] Dipl.-Ing. Mirko Hornung (dissertation): “Entwurf einer luftatmenden Oberstufe und Gesamtoptimierung eines transatmospharischen Raumtransportsystems”; Universitat der Bundeswehr Munchen; 2002
   [7] Ernst Messerschmid et al (reference book): Raumfahrtsysteme; 4th revised edition; ISBN 978-3-642-12816-5; Springer; 2011
   [8] THE POCKET RAMJET READER (reference book); CHEMICAL SYSTEMS DIVISION; 1978
   [9] Antonella Ingenito (reference book): Subsonic Combustion Ramjet Design; ISBN 978-3-030-66880-8; Springer; 2021;
   [10] Matthias Ziefuß (term paper): Dual-Bell-Diise; Deutsches Zentrum für Luft und Raumfahrt e. V. (DLR); Institut für Raumfahrtantriebe; 2016

### BACKGROUND OF THE INVENTION

### 1. Field of the Invention

The present invention relates to the field of aerospace, including the combination of air-breathing engine systems and conventional rocket engine systems, and relates more particularly to methods and devices for optimizing supply by means of oxidizers under variable conditions.

### 2. Discussion of the State of the Art

Getting from Earth to space requires the delivery of significant power in a relatively short time. Extensive decades of effort by some of the most talented and ambitious scientists, engineers and entrepreneurs have made viable solutions possible in the first place. The Earth's gravitational field, air resistance, and energy losses due to dead loads, etc., must be overcome. According to the current state of the art, chemical rocket engine systems are used to deliver payloads into Earth orbit and further into space (e.g. for satellites, spacecraft, transport goods, etc.). Here, an oxidizer is carried along and fed into the engine (e.g. oxygen). The mass of the oxygen can comprise up to about 75% of the total launch mass of the rocket (or spacecraft). For the fuel (e.g. hydrogen or methane) another 15% of the total launch mass can result. Of the remaining total launch mass, only a few percent of the total launch mass remains after subtracting structural mass, engines, and fuel for the effective payload. Depending on the target orbit or target object, this is typically about 1-4% of the total launch mass for low Earth orbit. Consequently, rocket launches are expensive, as well as technically and logistically demanding.

NASA has patented a multi-stage concept for a vertical launch into orbit using air-breathing thrusters (patent specification U.S. Pat. No. 8,047,472 B1). NASA is looking for licensees [4]. The first stage is intended to accelerate to Mach 2.6 with 18 turbine engines and reach an altitude of about 40,000 ft. With a possible 2nd stage, 15 reusable Ramjets are envisioned to accelerate to about Mach 4 to an altitude of about 101,000 ft. In a further rocket stage, acceleration into orbit is planned. This is referred to as the “RAM BOOSTER” concept (patent specification U.S. Pat. No. 8,047,472 B1).

Alternatively, research is being conducted, e.g. according to the Singer concept, on horizontal launches utilizing aerodynamic lift with the support of air-breathing engine systems (e.g. ramjets, scramjets). Among other things, this should reduce the mass of the required oxidizer. These systems are already in use and being tested in the non-civil sector.

The state of the art are combined rocket and ramjet propulsion systems, e.g. with Ramjets. These are referred to in [1] as rocket ramjet engines. Here, for example, a rocket engine is arranged centrally in the intermediate body of the inlet. See, for example, patent specification WO 2008/123868 A2. In patent specification U.S. Pat. No. 4,644,746, a gas generator is provided in the intermediate body (supersonic). The advantage of this concept is the increased velocity in the combustion chamber of the air-breathing engine stream. Air-breathing engine systems tend to exhibit improved performance values at increased inflow velocities, up to a specific maximum and then declining performance values again.

SABRE engines are an example of turborocket ramjets and a horizontal takeoff. The core component of the innovation of these engines is special high-performance coolers. SABRE engines are being developed for single-stage horizontal takeoff using air-breathing engines. These represent a combination propulsion system consisting of a turbo-ramjet and alternatively or further accelerating rocket propulsion. Officially, the decades-long work is now well advanced. The goal is to reduce the specific launch costs to a fraction of conventional rocket launches through reusability. The associated project for the “Skylon” space glider is available [5]. The propulsion concept provides for acceleration by means of a turbo ramjet to about Mach 5.4 at an altitude of about 26 km or about 85,000 ft (turbine engine specially designed for high speed and ramjet). This is followed by the necessary further acceleration into low earth orbit by means of integrated rocket engines.

The patent specification US 2014/0331682 A1 describes an aircraft launch system. The launch system uses a ramjet. The system is referred to as a high-speed-launch ramjet boost (HSLRB). The initial velocity for the ramjet is specified as Mach 2.2+/−0.2 Mach (≥Mach 2, but at least greater than Mach 1.5 with assistance). An adjustment device is provided in the inlet for optimum pressure. At the same time, this is intended to prevent thermal shock if the combustion chamber backpressure is too high. According to the patent specification, this makes it possible to achieve a specific impulse between Mach 2 and Mach 5.5, which corresponds to three to four times that of conventional rockets. This reduces the launch costs according to the patent specification.

Numerous systems with flaps and inlets have been patented or are state of the art for commercial and passenger aircraft. These systems are used, for example, for auxiliary engines in the tail of aircraft to supply turbine engines with inflow. For example, patent specification US 2010/0044504 A1 features an embodiment with retractable and flat inlets. Patent specifications U.S. Pat. No. 9,254,925 B2 and US 2019/0390601 A1 elaborate on hydraulic adjustable flaps equipped with and without additional adjustable transverse flaps, respectively. These systems are also shown level, for example, to facilitate adjustability. This despite the fact that the downstream rotating turbine engines require a circular engine duct. These systems can be used, for example, to provide additional thrust in special situations and to relieve the control of the other engines or refine their optimum design.

### 2.1 Disadvantages of the State of the Art

For engines in general, in the case of fully fed operation from entrained fuel components, the high proportion of the fuel in the total takeoff mass, in particular the oxidizer, must also be accelerated.

Engine concepts consisting of combination engines with air-breathing engines have been developed in order to reduce the proportion of fed oxidizer. In the case of special combination engines with parallel mixed operation of the engine components, disadvantages arise in mixed operation due to momentum transfer and friction. These disadvantages can affect the potential overall efficiency. Combination engines pose complex requirements in terms of development and profile compared to modular independent systems. For maximum performance, reliability and low cost of thrusters, simple and independent systems are often advantageous. The heat generated by friction, for example, may require complex pre-cooling. Also, the particular engine is necessarily more complicated and may be more costly to maintain a uniform flow in the combustion chamber through extended mixing zones. These systems are therefore currently limited to special applications [1]. Turborocket ramjet propulsion systems additionally include turbines. Concepts also exist for turborocket jet engines.

Air-breathing engine systems in particular can generally only be controlled to a limited extent. However, in order to use a variable inflow of air masses as extensively as possible chemically and to introduce it into the engine as efficiently as possible in terms of energy, there are high demands on the control system.

Among other things, these requirements entail
a variable geometry of the engine duct and
an efficient mixing range, and
high demands on ignition and combustion.

So far, this has led to decisive disadvantages for the design. High-performance air-breathing engines have so far been restricted to a limited range of applications. Moreover, variable geometries often mean complex additional systems. This results in possible further disadvantages such as additional development effort, risks, costs and weight. The possible changes in geometries are also limited.

Inhomogeneities in the merging of flows can arise, for example, if the flows are only merged at small contact areas, or with different vectors:
in the inlet system with inclined injection
in the inlet system with strongly differing incident flow velocities of the air mass flow and the different fluids

Circularly symmetric engine concepts have fluid mechanical advantages at limited speeds, but are limited in controllability compared to planar engine concepts and intakes.

Air-breathing engines, including subsonic ramjets, exhibit degraded burnout at low face velocities, or compression ratios, and wide operating ranges. The flexibility and performance of the ignition system is limited due to minimization of effort.

According to [1], due to decreasing air density at high altitudes, gas pressure decreases during combustion. Unstable conditions of combustion may occur.

Overall, for vertically launching propulsion systems into orbit, air-breathing propulsion systems are thus only suitable to a very limited extent so far due to strong changes in the decisive influencing factors. Low takeoff speed, variable inflow velocity and density of the air mass flow make it difficult to use air-breathing engine systems effectively for vertical takeoffs.

### SUMMARY OF THE INVENTION

The task of the invention is to increase the payload share on the basis of a propulsion concept that is as flexible and usable as possible. The propulsion concept should allow various operating possibilities, such as both as a support operation and as a single operation of the air-breathing engine system.

Possible solutions are described and compared below. Design variants are shown in the figures.

General:

The following building blocks of mass flows are used:
inflowing air mass flow of the inlet cross section of air-breathing engines
additional inflow of air mass flow through control systems, if necessary adjustable by means of control devices
if necessary, additional feed of an entrained oxidizer, e.g. in startup phase
if necessary, mixed operation of feed and incident air flow

Essential technical parameters concerning the Earth's atmosphere are recorded in the tables for the International Standard Atmosphere (ISA) [1]. These tables present the parameters as a function of altitude. According to these tables, the density of the atmosphere decreases by about 75% in the first 40,000 ft or or so and is less than 2% of the air density at sea level (about 1.23 kg/m³) after about 40,000 ft altitude. The pressure similarly decreases with increasing altitude.

Therefore, this concept for airborne operations focuses on the first 40,000 ft, although it can be extended beyond that.

Engine Systems

Due to the necessary broad distribution of velocity and density of the incoming air, a vertical takeoff places the highest demands or, at present, technological limits on the control and operation of air-breathing engines. There are absolute operational limits to the basic propulsion technologies (FIG. 2). Moreover, engines are typically designed for a limited operating range in order to reliably achieve maximum performance with the simplest possible design. Challenges exist for inlet, combustor, as well as nozzle. Air-breathing engines are optimized (pressure/temperature) for specific speeds and as constant flight altitudes as possible. In recognition of these conditions, patent application 10 2021 000 530.9 and other patent specifications, for example, cover the feeding or additional injection of an oxidizer for air-breathing engines. This is also intended to enable ramjets to be self-started by feeding.

Specific impulse is often used to assess the efficiency of engines. This indicates the burn time that the engine can maintain for a certain thrust with a defined amount of fuel. This means that a higher specific thrust means that less fuel has to be carried and thus less mass has to be accelerated. This is particularly crucial for rockets, where fuel sometimes accounts for more than 90% of the total launch mass. For air-breathing engine systems (e.g. turbines, ramjets, scramjets), the specific impulse is considerably higher, since there is generally no oxidizer to take into account. The specific impulse increases with the effective exit velocity of the ejected mass, since force is defined as the product of mass and acceleration. The unit is in German or metric: “Ns/kg”. In American, the specific pulse is used to calculate the acceleration due to gravity (approx. 9.81 m/s²). The unit is “s”- or the possible duration/burning time.

Since reusability is expected to be a key characteristic of propulsion technology in the future, comparable performance data from a Falcon9 rocket from SpaceX are used as an example. The specific pulse of the Merlin engines used is approximately 311 s at sea level [3]. Performance values for non-reusable systems are currently higher. For Ramjets, different specific pulses are achieved depending on the fuel. When using hydrogen, up to approx. 3,000-4,000 s specific pulse are achieved. When using other fuels, such as kerosene (hydrocarbon), lower specific pulses are achieved with Ramjets. Kerosene requires a mass oxidizer to mass fuel ratio of about 2.5 for stoichiometric combustion, which affects the required velocity and cross-sectional area of the incident flow. There are fuels with a lower stoichiometric ratio, such as AZ50 with a ratio of 1.3. There are also fuel combinations with a higher mixing ratio of oxygen to fuel, such as hydrogen of approx. 4. This results in a correspondingly additional required incident flow of atmospheric oxygen.

In principle, the Heber Concept can also be used to cover turbine engines. However, the following engines are considered in particular:
Subsonic ramjet engines (approx. up to Mach 2), air-breathing engines predominantly based on Ram effect,
Ramjet engines for supersonic (approx. Mach 1.5 to Mach 5),
dual-mode ramjet for supersonic and hypersonic (supersonic combustion from approx. Mach 5)

For subsonic jet engines, a specific pulse of at least 500 s with hydrocarbons is to be expected, starting at an approach velocity above Mach 0.75 [8] (FIG. 1). This corresponds to the state of the art in the 1970s. More modern air-breathing engine systems, for example, can significantly increase burnout at low approach speeds [9].

According to [1], for ramjets with hydrocarbons at about Mach 2.0, specific peak pulses of more than 2,000 s at most are achieved (FIG. 1).

For scramjets with exclusively supersonic combustion, approx. 1,000 s to a maximum of 3,000 s are achieved, depending on the velocity and fuel [6].

Preferred Geometries

The following methodologies are used to overcome the challenges of a vertical takeoff with maximum operational limits:
preferential use of flat inlet
flexible engine geometry—adaptive, e.g. sliding combustion chamber walls, flexible encapsulation of chambers, e.g. use of heavy duty pads/compressed air bodies, liquid bodies, further covering with metal fibers, or ceramic fibers if necessary (patent application DE 10 2021 004 784.2 from the same applicant)
adapted ignition for best possible ignition and combustion (e.g. contactless by electromagnetic waves—e.g. patent application DE 10 2021 001 272.0)
adapted combustion (if necessary catalytic combustion)
additional feeding by means of a carried oxidizer or alternatively acceleration by other engines (e.g. rockets/solid propellants)—in order to increase the starting capability of the engines
if necessary, fed mixed operation with incoming air mass flow and feed of entrained oxidizer

The following forms for guide systems are possible in front of an inlet for the additional inflow of air mass flows:
Axial guide systems (application e.g. for auxiliary engines for aircraft/“Auxiliary Power Unit”—e.g. patent specification US 2010/0044504 A1, inlet lips for scramjets).
Radial flaps
Concentric guidance systems
Polygonal guidance systems (e.g. models in nature such as head fins of giant manta rays or rays, use e.g. via contour of the missile, or targeted arrangement of the engines)

Especially in the start phase with low initial velocity, effects on the inflow velocity, or density, result. According to FIG. 1, the performance values of the air-breathing engines tend to improve when the speed is increased to a maximum.

The possible run-in figures are supplemented by shapes of engine and missile. With these engineering specifications, the following basic variants of engine plant cross sections remain:
Circular engine cross sections
Plane engine cross sections
Mechanically movable engine cross sections
Fluid mechanically/volumetrically displaceable engine cross sections

Round engine cross sections are often advantageous in terms of fluid mechanics and combustion kinetics. This engine shape also results in rotating axial compressors. In a wide speed range, however, controllability is more difficult. If axial compressors are not used, cross-sections that are not circular (e.g., by centrifugal compressors) can also be considered. However, according to the state of the art, the latter have disadvantages for the mass flow passed through them in terms of kinematics and, for example, multi-stage capability. Therefore, these centrifugal compressors are currently less interesting in terms of performance.

Flat engine cross sections form rectangular or uniformly elongated shapes. These can, for example, be rounded off according to nature, e.g. broad-based as in the mouth of the manta ray. By rounding out, acceleration can be achieved at the edge, if necessary, and the boundary layer can be adapted. The main goals in view are maximum controllability, at least medium efficiency and, in particular, a uniform flow field adapted as far as possible to the overall structure. This has already been explained under the methodologies for maximum operating limits based on inlets. The additional effort is justified by the desired reduction of the high share of the oxidizer in the total starting mass of up to approx. 75%. The kinematics of internal throttle valves and actuators on nozzles are extended by additional degrees of freedom compared to an exclusively axial displaceability with round cross sections. This is also frequently expressed in designs for scramjets according to the current state of the art. For example, an ambitious inclination of throttle valves in a round engine cross section results in an inhomogeneous flow field. Such a flow field can otherwise damage an engine under non-uniform loading.

Mechanically displaceable thruster cross sections can be realized, e.g., movable on one side on fixed thruster walls. Bearing-mounted supports, plates, hydraulic systems, pneumatic systems, actuators, motors, joints, etc. can be used for this purpose. Alternatively, the cross-section can also be folded in on a fixed outer wall. This can be implemented for rectangular or elliptical engine cross sections, for example. This further improves controllability but generally results in additional weight and development effort. In a further increase, the movable engine wall can be articulated or flexible on a rigid outer contour. This concept is common for self-launching Ramjets with additional feed of an oxidizer (e.g. patent specification U.S. Pat. No. 4,644,746). In a broader sense, the outer nacelle of the air-breathing engine systems can also be designed to be movable in the air mass flow, e.g., to respond to the aerodynamics of the rocket and guidance system.

Volumetrically flexible or displaceable engine cross sections can be adapted on one or more sides. Alternatively, the flexible cross-section can be restricted to certain areas, such as the inlet. In the following, an encapsulated structure is assumed. This means inner structure and separate outer nacelle. The outer nacelle can be optimized in terms of flow.

This concept of a controllable cross-section is based on a base structure, possibly composite structure and cover structure. The basic structure can be realized from pneumatic or hydraulic cushions, such as heavy duty cushions, flexible composite structure if necessary, also multi-layer and side-by-side multi-row. Pneumatic structures are weight-saving. A cover structure can be formed from stretched cover e.g. by flexible metal/ceramic fibers, ring armor/composite chains, connected metal plates—ideally extendable with counter-tension along the engine axis or e.g. overlapping. The cover structure can be manufactured undivided, or segmented to increase formability. If necessary, a composite structure can be designed between the base and cover structures. Advantageous are, for example, tensioning ropes, loops and lugs, or nets. In principle, the internal pressure of the thruster system acts against the base structure. The composite structure can, for example, allow the deck structure to be displaced relative to the base structure.

Advantageously, according to patent specification DE 696 20 185 T2 of Jul. 19, 1995, an appropriately structured surface (e.g. membrane) can have a positive technical influence on the boundary layer. Depending on the thickness of the boundary layer, different two-dimensional depressions are advantageous for this purpose. In one example given, the aerodynamic drag coefficient was reduced by approx. 15% at Mach 0.75. Ideally, flexibly supported surface layers can thus positively influence both the variable combustion kinetics and the flow-mechanical internal drag of engines.

Alternatively, according to patent application DE 10 2020 007 312.3, fibers or riblets close to the surface are also promising. The bionic model is the shark skin in nature. For cooling the riblets, reactive cooling by means of embedded flexible tubes, dense hollow fibers (e.g. in longitudinal direction) or also continuously released compressed air is possible. This can be used partially at neuralgic points such as areas of the intermediate body, or in the combustion area. Relief for the mainly intended application area of a vertical takeoff results from the expected burning time of maximum approx. 1.5 min and the thermal inertia of the structures, in particular due to the heavy load pads.

It is also possible to use flexible geometries in the area of the inlets and guide systems themselves to adapt volume and shape.

The underlying concept for adaptive engine systems and structures was filed as part of a separate patent application by the same applicant (DE 10 2021 004 784.2).

Ignition and Combustion

In addition to the shape and size of the inflow, combustion kinetics have a significant influence. Thermodynamic efficiency is determined by pressure, temperature and composition of the combustion mixture, or the safe operating limits of the engine. Further possibilities for optimization in the case of increased controllability requirements and for extending the safe operating limits exist through:
catalytic combustion (e.g. patent application DE 10 2021 000 701.8)
adapted ignition and combustion concepts (e.g. patent application DE 10 2021 001 272.0)
the named additional injection of an oxidizer, respectively feeding (e.g. patent application DE 10 2021 000 530.9).

The ignition concept according to patent application DE 10 2021 001 272.0, e.g. by contactless ignition via microwave and catalytic absorbers, makes it possible to eliminate aerodynamic resistance in the engine duct in the case of external transmitters. An adapted and changeable ignition field with the best possible burnout is possible. Advantages for controllability and performance values result in equal measure. The electrotechnical supply can be provided by generators of the turbopump, generators at the combustion chamber or thermocouples. Turbopump outputs are usually in the low range of the associated engines, so that a positive energy balance can be expected even with tapped load torque. In the case of ignition by electromagnetic waves, the ignition field can be selectively widened or, for example, placed in favorable cross-sectional areas.

This allows, for example, the higher flow pressure in the engine center for a better thermodynamic cycle, or a higher decoupling of combustion chamber to inlet. A possible useful addition to this is the Treiber Concept (patent application DE 10 2021 000 701.8) of the applicant of the same name, since the supply and constant presence of active catalysts in the combustion chamber tends to increase the combustion chamber pressure. This can prevent flameouts, for example. In this regard, for internal combustion engines, patent specification EP 1 833 594 B1 “Catalytic combustion reaction” refers to the fact that a higher pressure in the engine can be achieved with the catalytic system of the invention. According to patent specification EP 1 833 594 B1, this higher pressure can be maintained over a longer period of time. The Treiber Concept also aims to adjust the temperature.

The following comments refer to a vertical takeoff with air-breathing engine systems (e.g. using ramjets, scramjets). Vertical takeoff is an approach that runs counter to the Saenger Concept. The aim is to increase payload capacity. For this reason, this concept is also referred to as the “Heber Concept” in the following. Through the targeted use of guidance systems upstream of the engine intakes of the air-breathing engine systems, a vertical takeoff with air-breathing engine systems is made possible by additional and controlled inflow. In addition, the Heber Concept is supplemented by extensions to air-breathing engine systems by means of variable additional injection/injection of an oxidizer (see, for example, patent specification DE 10 2021 000 530.9) and adaptive engine geometry (patent application DE 10 2021 004 784.2 from the same applicant).

This improves the economic efficiency, or the overall efficiency of rockets. Future tasks such as space mining and space colonization can be realized. In principle, an application of the following concept is also possible for horizontal launches, or inclined trajectories “oblique launches”. This Heber Concept can be integrated into a multi-stage missile, e.g. with a conventional upper stage, or by means of separate air-breathing auxiliary engines (“boosters”). Both with integration in lower stage and with separate auxiliary engines, there is the possibility of parallel operation of conventional engines and air-breathing engines. Vertical take-offs from the earth's surface offer the advantage of the shortest possible route into orbit or away from the earth's surface. Air-breathing engine systems offer the advantage that no or less oxidizer (e.g. in a separate upper stage) has to be carried and accelerated. This results in energy advantages. The payload capacity can be increased as a result. Therefore, a concept for the combination is described below in order to achieve an optimized propulsion concept. In this way, the time-velocity characteristic of a vertical/inclined takeoff of conventional rocket engine systems can be matched to the range of use of air-breathing engine systems. It is possible to optimize the use of air-breathing engine systems by means of a designed guidance system and a control system. The control system increases the operational reliability of the air-breathing engine systems by preventing stalls and bypasses.

According to ISA (International Standard Atmosphere), the air density at an altitude of approx. 100,000 ft is only approx. 1.5% of the air density at sea level. Accordingly, high inflow velocities are required. According to the ISA, the pressure decreases to approx. 2% of the density up to an altitude of approx. 100,000 ft. If air-breathing boosters or sub-stages are used up to an altitude of 100,000 ft, the largest possible absolute differences in external pressure can thus be bridged before conventional rocket engines alone provide the further thrust. For the more inefficient combustion at varying external pressures, the air mass flow can thus be shared.

The external pressure is of great technical relevance for the chemical rocket engines currently predominantly used for optimum expansion at the nozzle outlet. According to [2], for example, the specific pulse of the Merlin 1 D engines in the lower stage is approx. 311 s at sea level and 282 s in vacuum. This means that the power in the lower stage decreases with altitude until burnout. At the same time, however, the mass decreases due to fuel consumption, so that acceleration nevertheless increases significantly. The vacuum-optimized Merlin 1D Vac. upper stage with other nozzles, on the other hand, delivers 342 s in vacuum. This results in a maximum difference of 18% for technical reasons. Even if this difference cannot be fully recovered, it opens up a wide range of options. For example, in line with the Heber concept, the proportion of air-breathing auxiliary engines and, at times, conventional rocket engines can be coupled variably. The increased complexity of an additional stage is offset by further effects from fuel savings. Saved fuel does not have to be accelerated. In the first 100,000 ft or so, it is estimated that a two-stage rocket such as the Falcon 9 uses about 20% of the total propellant mass of the lower stage. The proportion of oxidizer comprises about 80% of this. The proportion of “breathed” oxidizer can be changed and, if necessary, increased by adjusting or increasing the initial acceleration. An adjustment or bending of the rocket's trajectory with the typical gradual swing into the target orbit is also technically relevant.

### BRIEF DESCRIPTION OF THE DRAWING FIGURES

FIG. 1 a diagram of the performance of air-breathing propulsion systems according to various sources over several decades.

FIG. 2 is a diagram of the operating limits of air-breathing drive systems and characteristic speed limits.

FIG. 3 is a diagram showing the velocity curve of a rocket launch with conventional rocket engine system and characteristic velocity limits.

FIG. 4 shows a schematic diagram of a subsonic ramjet engine.

FIG. 5 shows the schematic structure of a ramjet (ramjet engine).

FIG. 6 shows a schematic diagram of a dual-mode Ramjet.

FIG. 7 shows a schematic diagram of a combination engine (rocket ramjet).

FIG. 8 shows the control system and trends.

FIG. 9 shows the control system and trends.

FIG. 10 illustrates a flat infeed system.

FIG. 11 illustrates an embodiment with additional feed of an oxidizer.

FIG. 12 shows a schematic of a basic shape with a radial inflow flap.

FIG. 13 schematically shows a manta ray

FIG. 14 schematically shows the basic shape with axial flow flap

FIG. 15 schematically shows the basic shape with concentric/polygonal inflow flap

FIG. 16 schematically shows the basic shape with a divided inflow flap

FIG. 17 illustrates a mechanical control system with flaps

FIG. 18 illustrates a mechanical control system with intermediate body

FIG. 19 illustrates a mechanical control system with movable combustion chamber wall

FIG. 20 illustrates a mechanical-volumetric control system of the inlet with cushions/beads for a uniform cross-sectional constriction

FIG. 21 illustrates a mechanical-volumetric control system of the mixing area with mats/cushions/beads for uniform cross-sectional constriction

FIG. 22 illustrates a mechanical volumetric control system with flexible mat for cross-sectional constriction

FIG. 23 illustrates a volumetric control system with cushions for a cross-sectional constriction

FIG. 24 illustrates a volumetric control system with cushions for a symmetrical cross-sectional constriction

FIG. 25 illustrates a control system with boundary layer suction or bypass

FIG. 26 illustrates designs of convergent divergent thrust nozzles

FIG. 27 shows the design variant of boosters with external inflow flaps in manta ray shape

FIG. 28 shows the design variant of boosters with internal inflow flaps in manta ray shape

FIG. 29 shows the design variant of self-contained boosters with internal inflow flaps in manta ray shape

FIG. 30 shows the design variant with lateral boosters

FIG. 31 shows a general energy consideration

FIG. 32 shows a special energy view with two freely selected states

### DETAILED DESCRIPTION

The inventor provides a system for using the atmosphere as an oxidizer in the vertical launch of rockets.

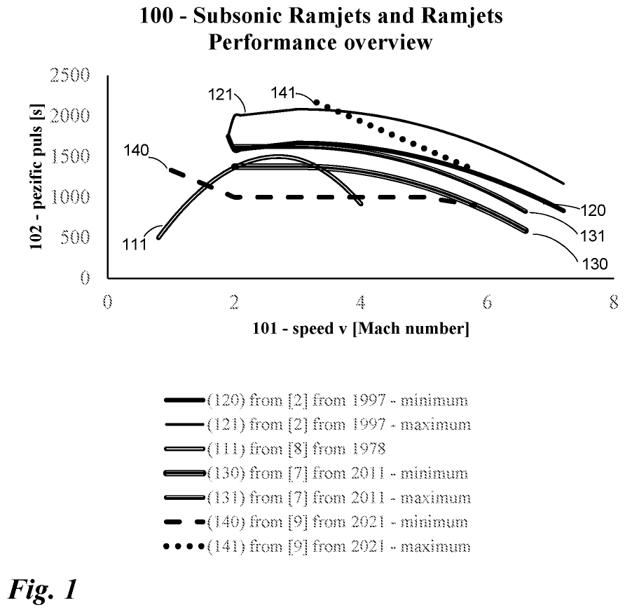

FIG. 1 shows a diagram of the performance characteristics of ramjets. Power values are shown for both subsonic and supersonic ramjets, each with state-of-the-art subsonic combustors (100). On the horizontal axis (101), the velocity is shown in [Mach Number]. On the vertical axis (102), the specific pulse is shown in [s].

Ramjet engines can be designed for face velocities from at least Mach 0.75 to over Mach 5. In particular, however, individual engines are only optimized for a specific range. In the following, performance values are given for both subsonic and supersonic ramjets, each with subsonic combustion chambers according to the state of the art (100). In each case, hydrocarbons such as kerosene are used as the fuel. To ease the burden, the parameters are shown both with figures and with identical textual descriptions.

Historically sorted are the power values from representative sources of several decades. Data from [8] are from 1978 and are shown as (111). Values from [2] published in 1997 are shown as (120) for the minimum and (121) for the maximum. Data from [7] published in 2011 are described as (130) for the minimum and (131) for the maximum. Data from [9] published in 2021 are recorded as (140) for the minimum and (141) for the maximum. Compared with (111) from 1978, the performance values are in some cases greatly increased and only fall short of (140) in some cases for minimum performance values of newer engines. (111), however, falls significantly short of the values of (141). A comparison of newer sources does not reveal any clear trend toward increased performance. The power values generally show a typical maximum value in the medium speed field at around Mach 3 and decrease again with increasing approach speed.

FIG. 1 shows that, particularly in earlier years with (111), lower approach velocities for subsonic ramjets were also investigated and presented. With [9] from the year 2021, approach velocities of approx. 0.5 Mach were also investigated. With the associated (140) it becomes clear that after more than 40 years of progressive development at Mach 1 about twice the specific pulse is state of the art. In [9], the focus is on maximizing burnout, e.g., by admixing additional propellant components and multi-row and improved flame holders. Depending on the conditions, burnout can thus be increased in some cases from about 50% to almost 90%. At around Mach 1.0, newer ramjet engines can already achieve specific pulses well in excess of 1,000 s. This is about three times higher at the peak. At its peak, this is about three times that of current rocket engines [9].

The large difference between minima and maxima shows further potential for optimization.

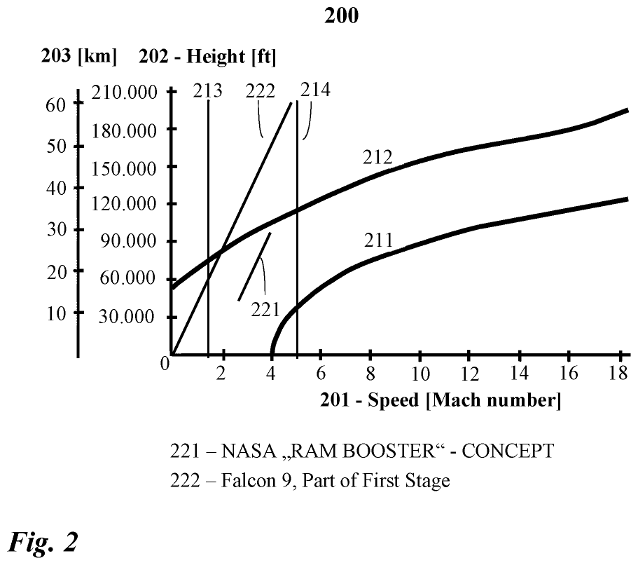

FIG. 2 shows the technical feasibility of air-breathing engines in a diagram (200) according to [9] from the year 2021. This depends on altitude (202) and speed (201). In FIG. 2, hydrocarbons such as kerosene are the basis of the illustration. The horizontal axis shows the speed according to Mach (201) and the vertical axis the altitude in ft (202) and km (203).

Since the density of air tends to decrease with increasing altitude, increasingly higher speeds are required at higher altitudes in order to be able to supply air-breathing engines with the necessary oxidizer. Progressive developments are extending the limits of use.

The diagram does not generally distinguish between turbine engines, subsonic ramjets, ramjets or scramjets. The overall range of the respective operational limits is covered. (211) represents the lower limit of deployability and (212) represents the upper limit of deployability. By (213), the typical minimum speed of ramjets is shown to be about Mach 1.5. Below that, the use of subsonic engines or ramjets with launch aids, or e.g. the additional feeding by carried oxidizer, is possible. At (214), an upper speed limit for ramjets with hydrocarbons of about Mach 5 is given. In addition, operation of dual-mode Ramjets with switching to supersonic combustion is possible. The use of scramjets with only supersonic combustion is an alternative. Speed limits vary in the literature depending on publication date and fuel.

(221) shows the characteristic curve of the “Ram Booster” concept of the National Aeronautics and Space Administration (NASA) with the intended use of a ramjet as second stage (of 3 stages). Upstream, the operation of 18 turbine engines in the first stage and downstream, the operation of a rocket engine in the third stage is conceived. This is intended to utilize the largest possible specific pulse. (222) shows part of the characteristic curve of the lower stage of a Falcon 9, which is still operated up to approx. 84 km or 276,000 ft.

From the plot, it is clear that with the typical speed profile of a Falcon 9, effective operation of a typical ramjet would not be possible, since the allowable operational limits are almost entirely outside the intersection of (213) and (222). Also, with (212) and (214), a limit of operation of a ramjet up to an altitude of at most about 100,000 ft altitude is still technically possible.

Additional measures are therefore required to accelerate a reusable lower stage by means of air-breathing engine systems. One possible measure is to increase the thrust-to-mass ratio of the rocket in order to accelerate more strongly in the denser air layers and to be able to use the atmospheric oxygen earlier and more intensively. Another measure is to increase the inflow to the air-breathing engine systems in order to partially increase the inflow velocity at the engine inlet (Heber Concept). According to FIG. 1, a higher inflow velocity also increases the specific pulses of the engines up to a maximum. In addition, the air-breathing engine systems can also be fed by supplied oxygen. In order to achieve the greatest possible proportion and effect, it makes sense to operate the engine in a mixed mode with a variable proportion of supplied atmospheric oxygen at higher altitudes.

The required operation of air-breathing engine systems over the maximum possible speed range or at large altitude differences is a challenge.

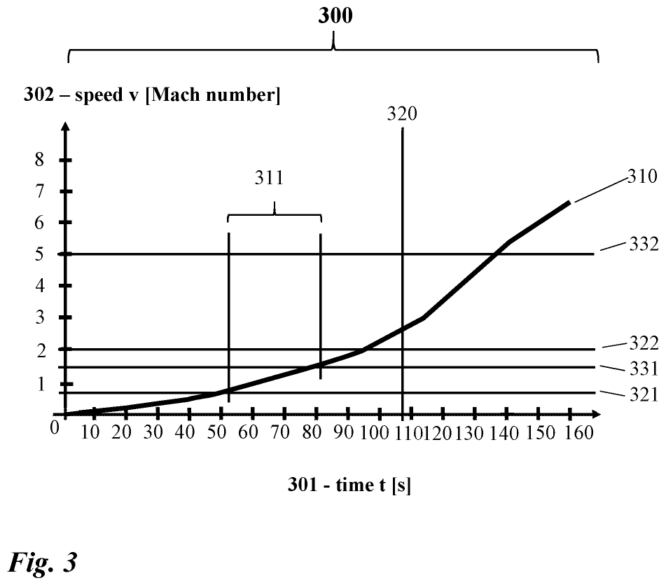

FIG. 3 shows in a diagram with (300) the typical velocity profile of a rocket launch (e.g. Falcon 9). With its partially reusable lower stage, the Falcon 9 represents a pioneering and promising technology.

On the horizontal axis, the time is shown in [s] (301). On the vertical axis, the velocity is shown in [Mach] (302). The course of the velocity increases with increasing time. This is due to the decreasing weight of the rocket (fuel combustion). With (310) the typical velocity curve is shown approximately. After approx. 162 s, the stage separation of the lower stage occurs at approx. Mach 6.7.

The diagram in FIG. 3 shows typical speed limits for engine types. For the sake of simplicity, the fact that air-breathing engine systems have a further dependency on altitude (air density) is neglected here. This is shown in simplified form in FIG. 2. After approx. 110 s, regular operation of air-breathing engine systems is no longer possible with the given parameters (acceleration, speed, trajectory). This limit is represented by (320). With (321), the lower speed limit for subsonic ramjet engines is represented. With (322) the upper speed limit for subsonic ramjet engines is represented. For good order, (331) represents the lower velocity limit for powerful ramjets. This speed limit is relevant to show that with (320), the altitude-based operational limit is exceeded only briefly later by (310). Without additional measures, ramjets would not be relevant, especially the upper deployment limit of ramjets (332). According to the time portion of (310) limited by (321) and (322), air-breathing operation with ramjets is only possible in a maximum of about 33% of the time of the rocket launch (311). Due to further influencing factors (e.g. actual inflow oxidizer), required thrust, high controllability, further measures are reasonable. It is interesting that inversely to speed limits, the altitude limit is crossed prematurely (320).

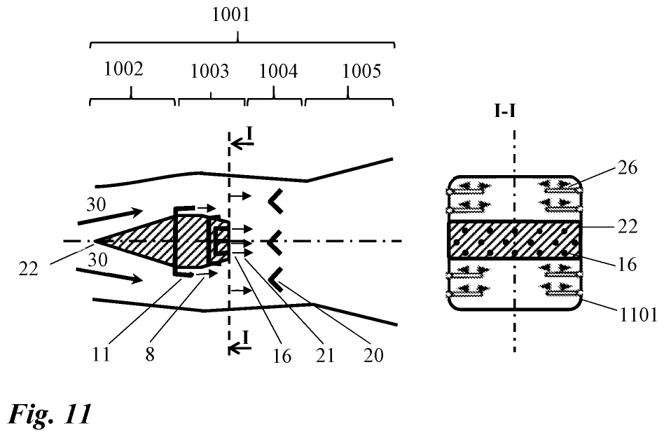

Possible measures are:
increasing the thrust-to-mass ratio for greater acceleration in line with the increased acceleration at burnout of lower stages (e.g., on a Falcon 9),
additional injection of an oxidizer in air-breathing engine systems (e.g. FIG. 11)
higher speed/compression on the engine due to additional inflow,
parallel operation of the air-breathing engine system with conventional rocket engine for increased acceleration, variable if necessary
Extension of the controllability of the air-breathing engine system—e.g. use of a switchable subsonic ramjet engine/supersonic ramjet with subsonic combustion in each case

Subsonic ramjets sometimes achieve specific pulses two to three times that of classical rocket engines. Ramjets can convert with hydrocarbons according to [1] even at a maximum of approx. 2,000 s at approx. Mach 2-3. This corresponds to about five times the specific pulse of conventional rocket engines. However, this peak value is only reached in a narrow design range in each case. A higher specific pulse means that less propellant has to be carried and accelerated. The possible mass shift can be used to increase the payload fraction.

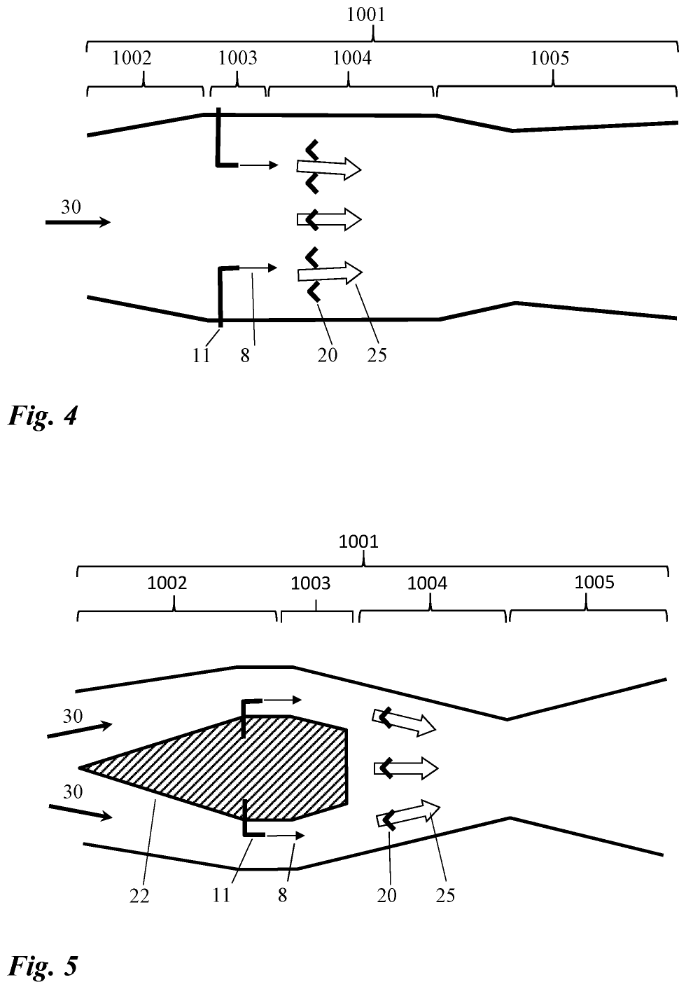

FIG. 4 shows the basic form of subsonic ramjet engines. These engines are relatively simple in design. Since they have only a fraction of the specific pulse of turbine engines, they are only used for simple missiles.

The air mass flow (30) enters the engine duct (1001). The flow (30) is decelerated in the diffuser or inlet (1002). The subsonic ramjet, or Lorin jet pipe, introduces the air mass flow (30) with a low compression ratio. Fuel (8) is added in the mixing section (1003) via the injection (11). In the combustion chamber (1004), combustion (25) takes place in the area of the igniters or flame holders (20) with the highest possible burnout of air mass flow (30) and fuel (8). There are various forms and arrangements of igniters, or flame holders (20), some of which are multi-row. Development is not complete and, according to [9], is one of the main factors influencing optimum burnout. Combustion (25) can thus take place supported on calmed flow zones on flame holders (20). Alternatively, contactless ignition, e.g. via electromagnetic waves, is possible. Downstream of the combustion chamber (1004), the nozzle (1005) optimally converts the thermal energy of the combustion into usable thrust. A converging-diverging nozzle shape (1005) is shown.

For subsonic ramjets, a maximum speed of simplified about Mach 2 is considered. In addition, the increasing combustion chamber pressure (thermal backpressure) typically “blocks” the inlet (1002). The resulting scavenging of the engine duct (1001) makes the engine increasingly ineffective. Beyond Mach 2, a higher compression ratio is required (FIG. 5).

FIG. 5 shows a schematic of a ramjet. From about Mach 1.5, ramjets with a more complex inlet (1002) in the engine duct (1001) can be used effectively. The inlet, or diffuser (1002) retards the flow (30) more than subsonic ramjets, or FIG. 4. Combustion (25) in the combustion chamber (1004) at the igniters (20) also occurs at subsonic speeds. An intermediate body (22) is shown in the typically concentric inlet (1002). According to [1], the resulting annular combustion chambers have the best characteristic values. The inlet (1002) with intermediate body (22) shields the combustion chamber (1004) more strongly from the inlet (1002) than in FIG. 4. Downstream of the inlet (1002), the mixing region (1003) is present. In the mixing area (1003), the fuel (8) is supplied by the injection (11). Advantageously, the flow cross-section in the combustion chamber (1004) increases. The resulting combustion chamber pressure can thus be distributed over a larger area. Under suitable conditions, a higher thrust can be used at the nozzle (1005) than in FIG. 4. By design, this prevents premature blocking of the inlet at higher combustion chamber pressures or inflow velocities. At very high inflow velocities, the lossy deceleration can be energetically disadvantageous compared to supersonic combustion. In this respect, dual-mode Ramjets are advantageous, which permit supersonic combustion above a defined velocity.

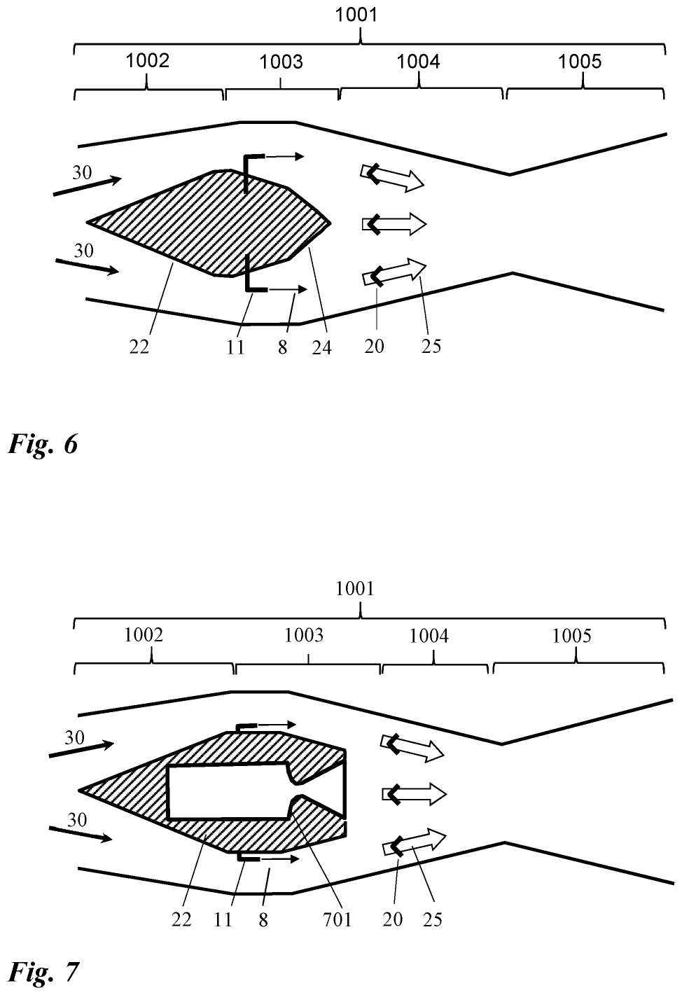

FIG. 6 shows a diagram for supersonic combustion. Supersonic combustion can be energetically advantageous for higher inflow velocities, since the air mass flow (30) in the engine duct (1001) does not have to be decelerated into subsonic and then accelerated again.

In the embodiment shown, the intermediate body (22) has a downstream pointed contour (24).

Compared with FIG. 5, FIG. 7 additionally has a conventional rocket engine (701) in the intermediate body (22). The additional inflow to the combustion chamber (1004) can further increase the combustion chamber pressure and increase the flow velocity in the combustion chamber (1004) of the air-breathing engine system. Optionally, continuous operation of the rocket engine (701) or variable auxiliary operation is possible.

According to [1], this involves additional complexity. Friction during the mixing of different fluids in the mixing area (1003) results in higher thermal stress on the combustion chamber (1004) and additional detrimental energy conversions.

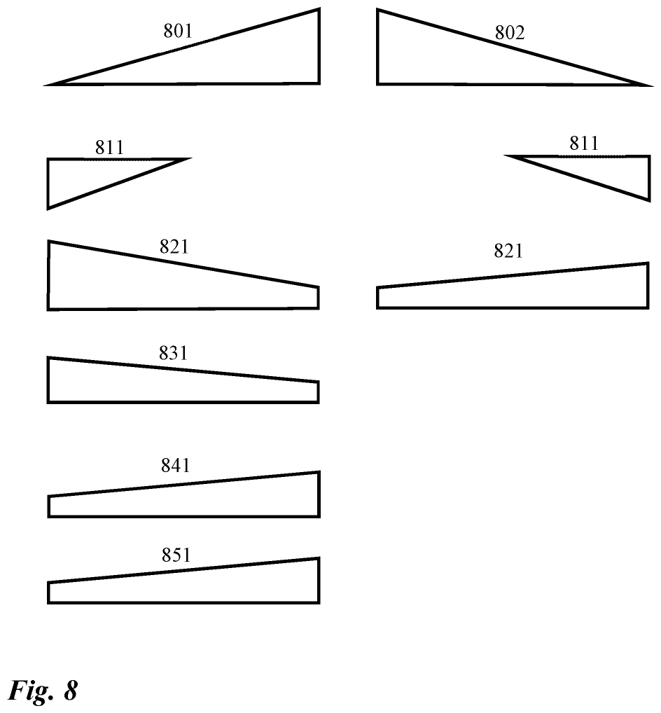

FIG. 8 shows a simplified representation of the control scheme designed for air-breathing engine systems for use in the Heber Concept.

According to FIG. 2, air-breathing engine systems are influenced in particular by the parameters speed (801) and altitude (802).

The following variables are used to control air-breathing engine systems (2) at different pressures:
Freights of additionally injected oxidizer (811),
effective area of additional inflow (821),
injection of fuel into combustion chamber (831),
adjustment of compressor ratios (841),
flow cross-section in the thrust nozzle (851).

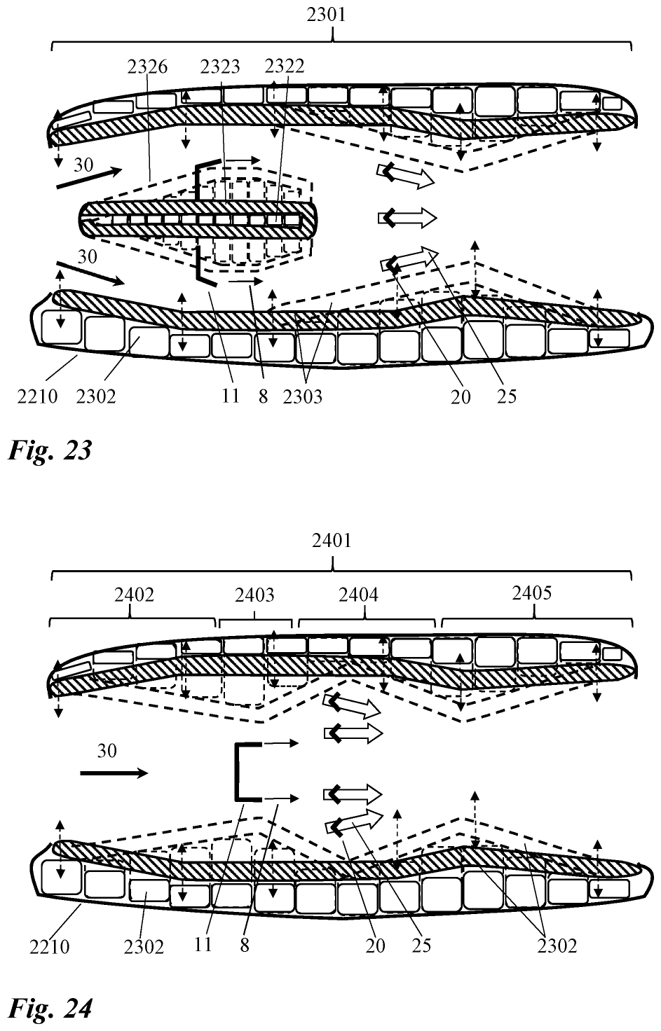

If necessary, further control variables such as variable geometries of the inlet and other areas, boundary layer suction, air outlet flaps, air inlet flaps, control of surfaces can be additionally adapted. With the control of loads of additionally fed catalysts and the adaptation of the ignition by electromagnetic waves (e.g. microwaves) further control methods are available. See the patent applications of the same applicant (DE 10 2021 000 701.8 and DE 10 2021 001 272.0). Ideal are the flexibilized geometries and the adaptive engine concept (patent application DE 10 2021 004 784.2 from the same applicant), respectively, e.g. FIG. 23 and FIG. 24 (patent application DE 10 2021 004 784.2 of the same applicant).

The influencing variables are grouped for a highly simplified and rough control program, ordered by tendency of pressure/velocity (801) and density/height (802). The sizes of the gradients are freely chosen for illustration and depend on inner and outer boundary conditions for permissible values of the sizes. By superimposing the course of velocity (801) and height (802), the effects can be partially cancelled.

With increasing velocity (801) of the inflow, the pressure in the inlet increases, which, according to the Carnot process, increases the internal area and thus the work of the cyclic process. This tendency is superimposed by the strongly decreasing density of the air with increasing height (802) during a vertical start.

According to [1], the compressor or inlet pressure ratio is optimized together with turbine inlet temperature and Mach number. The ratio of outlet to inlet pressure can be adjusted by the geometry of the inlet. The higher the temperature, the higher the optimum compressor pressure ratio. This also increases the M-number for the maximum thrust. These adjustments are particularly necessary for supersonic engines. In principle, however, the temperature can also be adjusted by using catalytic combustion (see patent application DE 10 2021 000 701.8).

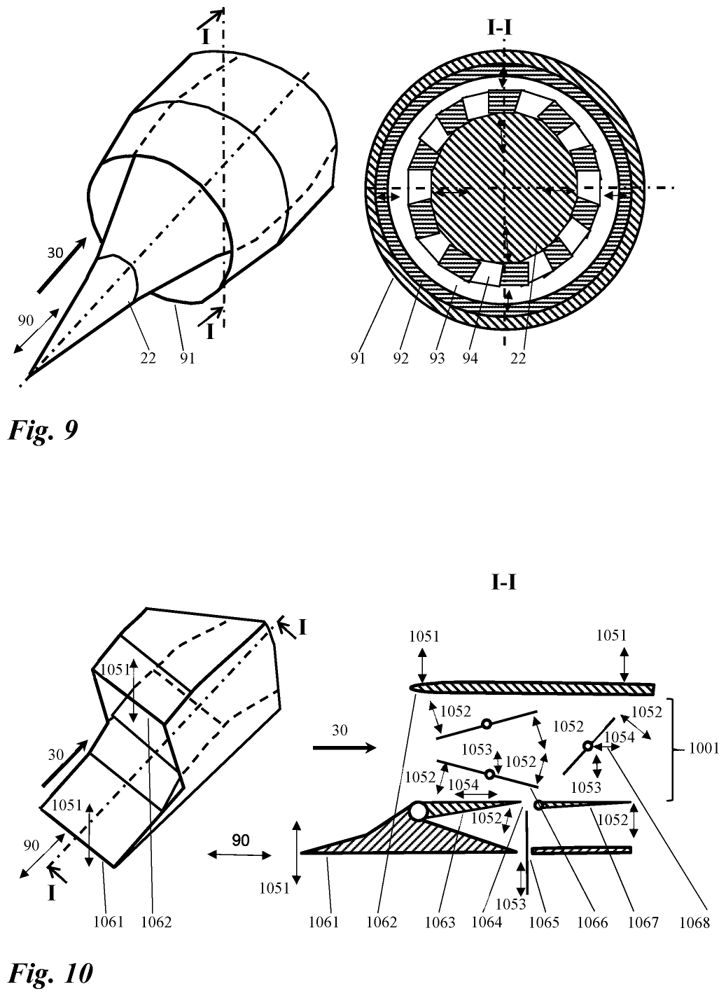

FIG. 9 shows an axially symmetrical inlet. This well-known inlet concept is explained in [1]. The concentric shape generally results in fluid mechanical advantages. In particular, however, energetically disadvantageous shock systems can result from supersonic pressure shocks at higher incident flow velocities.

The intermediate body (22) shown is typical for higher incident flow velocities of an air mass flow (30) that is as coaxial as possible. The intermediate body (22) projects well beyond the leading edge of the remaining engine duct (91).

A characteristic feature of this inlet shape, or a uniformly downstream axially symmetrical engine duct, is the sophisticated controllability of the flow geometry. The most uniform and homogeneous flow situations possible in the engine are essential for control.

For illustration purposes, a cross-section with I-I is shown. (92) shows a bead that can be pressed on (e.g. made of metal/ceramic fibers). This can be mechanically expanded and retracted, e.g. by means of hydraulics. Due to transverse elasticity and deformability, the annular gap (93) is uniformly gripped and delimited. The flow, or air mass flow (30) in the annular gap (93) can thus be uniformly influenced. On the inside of the annular gap (93), actuators (94) are indicated. However, this intimation with alternating pattern of black and white is to represent the complexity required for such kinematics. The requirement for thermal (thermal expansion), material (impurities, adhesions) and mechanical stresses on the flow would be enormous. It is therefore essential that the intermediate body (80) can be moved along the flow axis.

The degrees of freedom of the control with concentric inlet are limited and the requirements are high. This form of control is not claimed by this patent application. FIG. 9 serves as a technical illustration.

FIG. 10 shows a flat inlet. This well-known inlet concept is explained in [1]. In the following, control possibilities are added. These regulations are not claimed in this patent specification.

Plane bodies are more freely movable in plane structures. Resulting degrees of freedom of the controls are shown by the numerous motion arrows (1050), (1051), (1052), (1053), (1054). For simplicity, the degrees of freedom are designated uniformly. Movements with respect to the inlet plane are summarized by (1051). Movements affecting rotations or circumferential movements, e.g., in flaps (1066), are essential with (1052). Movements perpendicular to the flow are summarized with (1053). Movements in flow direction are shown with (1054).

In the embodiment FIG. 10, a flat inlet with a two-part ramp (1061) is shown. The air mass flow (30), the ramp (1061) and the opposite wall (1062) or lip are shown approximated to the isometric representation and in a longitudinal section (I-I). The front section is displaceable in longitudinal axis (90) according to FIG. 9.

A flap (1063) is arranged at the leading edge to allow suction (1064). In addition, a gate valve (1065) is shown for increased control of the bypass, or engine duct (1001). Flaps (1066) are arranged in the engine flow (1001), which can divide, or shift, the incoming air mass flow (30). Two flaps (1066) in the engine stream (1001) have the ability to rotate (1052). Another flap (1068) has the capability of longitudinal displacement (1054) and transverse displacement (1053) in the engine flow (1001). The aim is to variably increase the compression in the inlet of the engine stream (1001).

The choice of flaps is such that an intermediate body as in FIG. 18 can be approximated by movements. A movable cross-section is formed by moving the outer wall (1062). For simplification, a separate outer nacelle is missing in FIG. 10.

Therefore, to enable more controllable systems, planar shapes according to FIG. 10 are more suitable than axially symmetrical ones (e.g. FIG. 9). It should be noted, however, that combinations are also possible. For example, a combination of a flat inlet and a downstream axially symmetrical engine duct can be used. This compromise between a smooth inlet and a concentric engine duct with favorable flow characteristics is illustrated, for example, in patent specification U.S. Pat. No. 6,786,040 B2. Patent specification U.S. Pat. No. 6,786,040 B2 contains a self-starting system with additional oxidizer feed for low starting speeds or unfavorable inlet flow conditions. The additional resistance at the cross-section change (flat to round) is offset by fluidic advantages in the concentric area of the combustion chamber.

The embodiment of FIG. 11 is based on FIG. 2b of patent application 10 2021 000 530.9 of the applicant of the same name for this patent application. However, instead of a concentric cross-section, FIG. 11 shows a flat engine cross-section. The application is tailored for a vertical takeoff without, or with a low initial speed. In the case of variable inflow conditions, fed mixed operation is ideal in order to utilize as much of the inflowing oxidizer as possible.

Fed air-breathing engine systems can be used to increase performance:
for self-starting and with highly variable conditions
for the combination of exclusively air-breathing engine systems with fed-air-breathing engine systems and distribution of the incident flow, e.g. via a control system that can be modified via a control system
in addition, with exclusive supply also outside denser atmospheres

During startup, the additional injection of an oxidizer is required due to the lack of incident flow of the air mass flow (30). In this embodiment, additional injection systems (16 and 26) are provided. These inject over a large cross section along the air mass flow (30). The mixture (21) is injected via the fixed injection (16) at the intermediate body (22) in the head of the combustion chamber (1004) and the movable injection (26). Movable lances (26) with devices for injection are extended in the area of the engine duct (1001). Ideally, the lances (26) are rotatably mounted on the side walls (1101). However, in order to relieve the mechanical system, simple displaceability (translation) is also possible. The lances (26) are inserted at an angle into the engine duct (1001) to cause as little flow resistance as possible and to prevent jamming during backward movement. The lances (26) are designed in such a way that they counteract the incident flow or the combustion chamber pressure with a higher area moment of inertia. This means that the cross-section of the lances (26) is longer than wide, the length being aligned with the longitudinal axis (1001) of the engine. The lances (26) also have a flow-favorable, e.g. teardrop-shaped, cross section. The lances (26) can be mounted on the outside of the engine or on the side walls (1101), or on the inside of the intermediate body (22). In the embodiment shown, the lances (26) are mounted externally on the fixed side walls. The lances (26) are moved by means of a hydraulic system; alternatively, cushions or electric motors/actuators with corresponding power are also possible. At the same time, fuel is injected via the injection (16 and 26) in a mixture (21). Nozzles are arranged at several points on the lances (26). Multi-directional nozzles are preferably used for this purpose. The atomized mixture (21) is ignited in the combustion chamber (1004).

The additional injection of oxidizer in the mixture (21) is adapted to the air mass flow (30), or reduced if necessary. As the speed of the air mass flow (30) increases, more oxidizer flows into the combustion chamber (1004). The adjusting device with the movable lances (26) is retracted, or retracted. No major internals of the self-starting aid, or of the additional injection systems (16 and 26), remain in the engine duct (1001) when the engine is shut down. The additional injection systems (16 and 26) are deactivated in the preferred embodiment. However, the additional injection systems (16 and 26) can optionally continue to be operated to increase power, or can be put into operation again. The fuel (8) is otherwise injected via the control injection (11) and mixed with the air mass flow (30) in the mixing chamber (1003). If necessary, it is switched to injection of the fuel (8) via the control injection (11).

The inlet is designated by (1002) and the nozzle is designated by (1005).

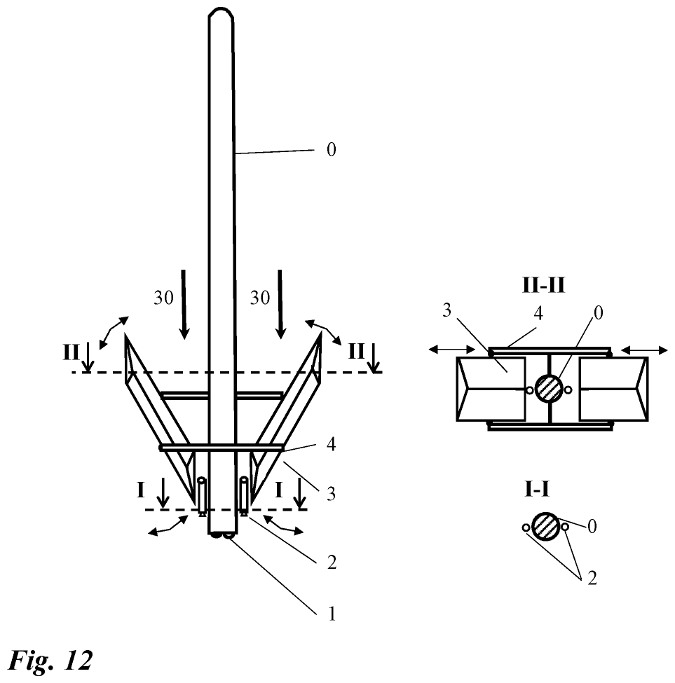

FIG. 12 shows a schematic diagram of the additional guide systems (3) according to the invention, in which the main extension or mobility of the inflow surface is radial to the flow axis.

When the rocket (0), or the missile, is launched from the ground, 2 laterally arranged inflow flaps (3) are extended in the maximum position for the largest possible inflow area perpendicular to the velocity vector via the control system (4). The inflow area is extended and, if necessary, retracted again depending on flight time, speed and altitude/atmospheric density.

This results in an inverted “arrow” in the direction of flight, the arrowheads of which tilt and, if necessary, open again. In the case of two opposing leading edge flaps, the mechanics of the system can be simplified, e.g. by mutual bracing of the leading edge flaps. These geometries are already state of the art in a similar form for auxiliary power units on commercial aircraft (e.g. for increased thrust)—see e.g. patent specifications US 2010/0044504 A1, U.S. Pat. No. 9,254,925 B2, US 2019/0390601 A1.

In FIG. 12 the invention comprises, among other things, a propulsion concept (Heber Concept) by possible combination of “conventional” rocket engine system (1) with entrained oxidizer or solid, air-breathing engine systems (2), possibly in fed mixed operation, and guidance system (3) for additional inflow of atmosphere or “air” (30). To maximize the efficiency and extend the range of application, the control system (3) can also be adjustable or equipped with a control system (4).

The conventional rocket engine system (1) launches the missile for a predominantly vertical trajectory in order to achieve a takeoff speed; if necessary, the air-breathing engine systems (2) are fed with oxidizer by self-launch aid. During regular operation, the airflow (30) is sufficiently compressed, or accelerated by the speed and thrust of the rocket, or fed in compressed form into the air-breathing engine system (2). The novel guidance system (3) can be used to increase the required compression/flow rate of the atmosphere or air (30) with additional inflow. Optionally, the air-breathing engine systems (2) are designed to be adaptive or adjustable to cover a wider range of applications (patent application DE 10 2021 004 784.2 from the same applicant). Atmospheric oxygen (30) is utilized and the entrainment/acceleration of an encapsulated oxidizer can be reduced. The control system (4) can adjust the incident flow area of the guidance system (3) to speed and altitude/or atmospheric density. At higher altitudes with thinner atmosphere or air (30), the incident flow area of the guidance system (30) can be increased again. The guidance system (3) and control system (4) thus provide for a larger operating range of the air-breathing engine system (2) at lower speeds of the rocket (0) and also at greater altitudes. The flow of the air mass flow (30) is adapted to the speed of the flying object.

The aim is to integrate the air-breathing engine system (2) at an early stage into a variable aerodynamic system with the aid of a guidance system (3) and control system (4). Via the control system (3), additional incoming atmosphere or air (30) is guided as completely as possible to the air-breathing engine system (2). After the air-breathing engine system (2) has been launched/operated, the conventional rocket engine system (1) can be separated from the missile as a “sub-stage”. In this way, the percentage of expendable payload can be further increased. Optionally, the oxidizer to be carried can be minimized. Alternatively, the conventional rocket engine system (1) can continue to operate, be decommissioned and restarted for higher altitudes, or orbits. The air-breathing engine system (2), guidance system (3) and control system (4) can be separated before reaching the target orbit and the missile can continue to be operated with one or more conventional upper stages. The control system (3) and guidance system (4) prevents stalls on the air-breathing engine system (2).

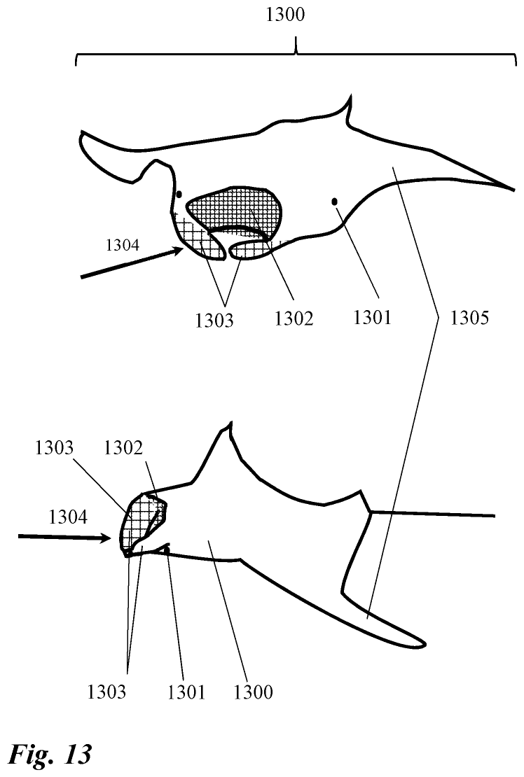

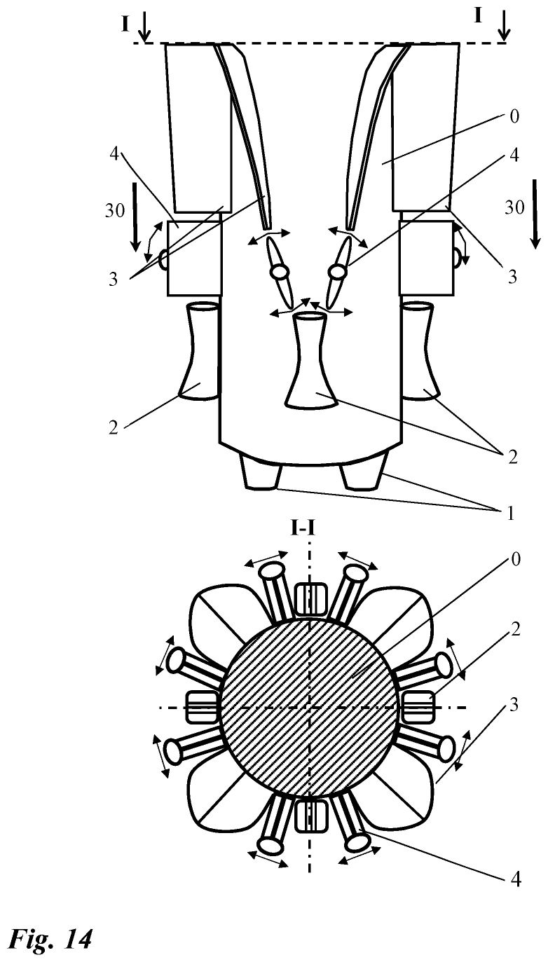

FIG. 13 shows a simplified manta ray with head fins (1303). The model is nature. The basic bionic idea is based on model laws. Hydrodynamic flow tests for aerodynamic boundary conditions are technically/historically known.

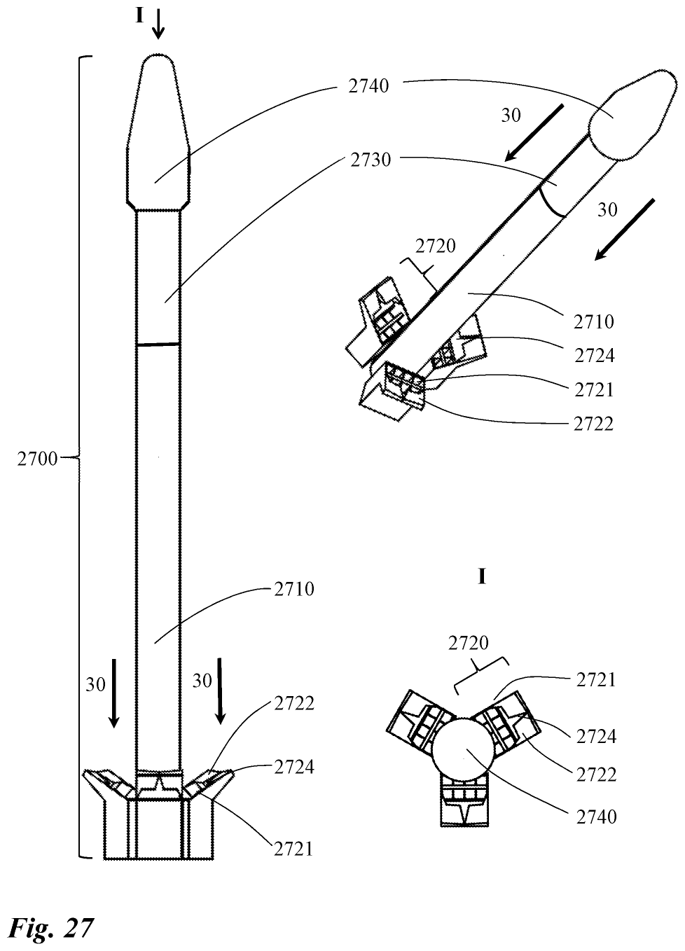

This design variant is technically approximated in simplified form in FIGS. 27, 28, 29 and 30.

The body of the manta ray (1300) with the large fins (1305) has a broad mouth (1302) at the front part with head fins (1303) in front. The animal is propelled by constant movements of the fins (1305). Water and biomass flows into the mouth (1302) as a mass flow (1304) with plankton and small creatures and is discharged again via flaps/gills.

Eyes (1301) are shown for better illustration.

FIG. 14 shows guide systems in which the main extension runs along the flow axis of the air mass flow (30).

In this embodiment, a guidance system (3) is arranged along the rocket (0). The axial guidance system (3) discharges at a control system (4) of movable inflow flaps. The air-breathing thruster system (2) detects the aerodynamic flow around the rocket (0) with the incoming air mass flow (30). For improved controllability, the air-breathing engine systems (2) in this embodiment are shown with a planar inlet. At the same time, a targeted additional inflow is effected via the additional inflow surface (3). In this variant, air-breathing engine systems (2) are arranged directly on a lower stage of a rocket (0). Alternatively, an arrangement on separate auxiliary engines or boosters is also possible.

After leaving the denser air layers, the air-breathing engine system (2) is disconnected or continues to operate via an additional feed of an oxidizer. The air-breathing thruster system (2) can be disconnected from the upper stage, or payload. The payload continues to move.

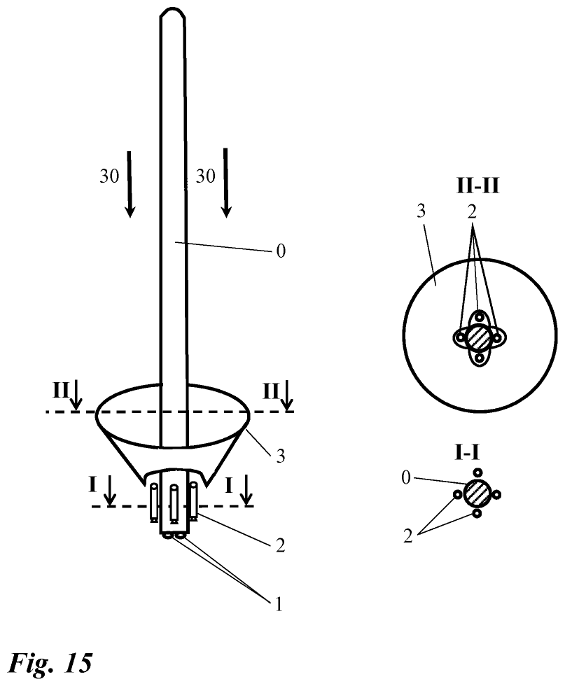

FIG. 15 shows a schematic sketch of a basic shape with concentric/polygonal inflow flaps. For the best possible utilization of the surrounding airflow and additional inflow with the increased air mass flow (30), a funnel (or more if necessary) is installed as a guidance system (3) on the rocket (0) (or on the missile). Air-breathing engine systems (2) and conventional rocket engines (1) can be operated in parallel if necessary. After leaving the denser air layers, the air-breathing engine system (2) is disconnected or continues to operate via an additional feed of an oxidizer. The air-breathing thruster system (2) can be disconnected from the upper stage, or payload. The payload is moved into orbit.

Alternatively, or in further development, supplementary parachute systems, or chutes, nets made of fibers or textile guidance systems can be used to increase the inflow, which can be used up to a maximum speed, or wing load. After the surface load has been exceeded, it can then be selectively separated or retracted, if necessary. These systems can also be combined with other approach flaps. The favorable ratio of mass to maximum area is particularly advantageous in the takeoff phase in order to achieve speed quickly.

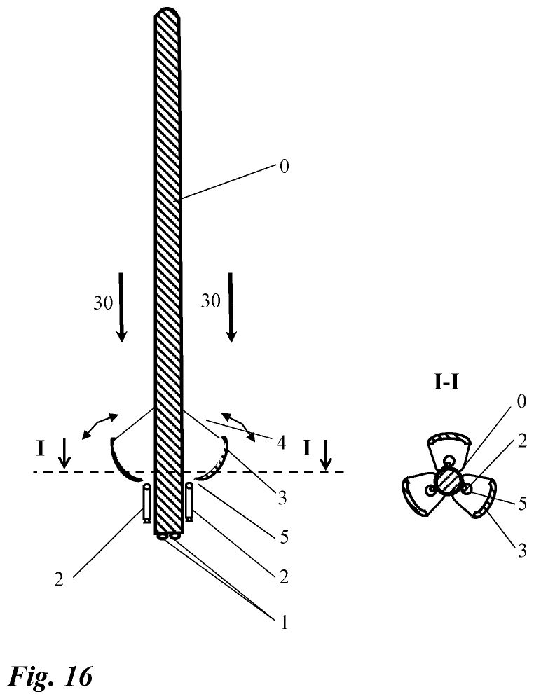

FIG. 16 shows a design variant with a guide system (3) consisting of divided half shells (or more if necessary) on the rocket (0). Half-shells, or rounded shapes, can have lower fluidic drag values than straight contours when the air mass flow (30) is favorable. The control system (4) consists of ropes or, if necessary, flat ropes and movable mounting or adjustment of the half shells (3) or the control system (4). The flat ropes are pulled into the rocket and the guidance system (3) is retracted or controlled. The guidance system (4) can be extended again.

A free air mass flow (30) can be developed between the guidance system (3) as a bypass. In order to prevent the guide system (3) from being bypassed, the guide system includes a passage device (5).

For a favorable ratio of structural mass to payload, the three-part guidance system (3) is countered on cables which can be shaped as flat cables. This allows a more targeted inflow (30) to the air-breathing engine systems (2). At the same time, this reduces stalls or undesirable flow around the engine and allows more targeted control (4) of the guidance system (3).

Alternatively, flexible nets or further flat cables on the sides of the split guide system (3) are also possible to prevent air mass flow (30) from flowing off. Thus, a higher air mass flow (30) can be supplied to the air-breathing engine system (2).

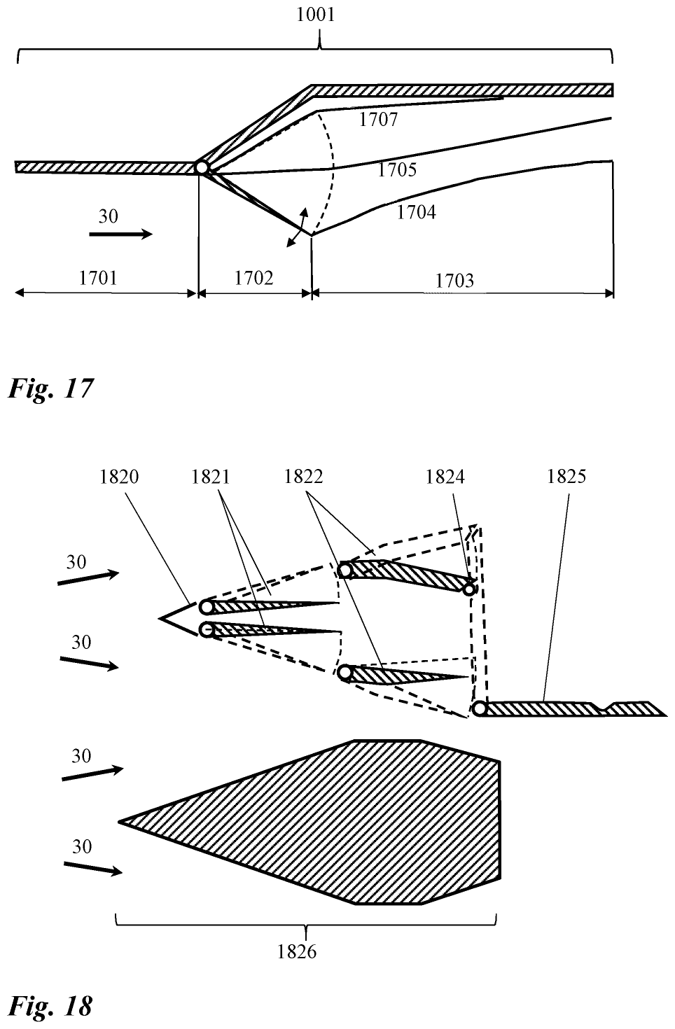

FIG. 17 shows a sketch of a mechanical control system using flaps. Dampers (1702) can influence the air mass flow (30) in the engine (1001). This principle is shown for information purposes in this example. No claim to protection is made here.

The illustration of FIG. 17 is freely derived from an illustration for an ejector thrust nozzle according to [1]. In this illustration, a flow pattern is shown which can vary greatly depending on speed, density and turbulence and is only intended to approximate the complex character in a simplified way. Thus, in addition to the contour, the absolute flow rate and the flow velocity can also be changed under certain circumstances. In addition to partially influencing the air mass flow (30), engine flows can also be completely shut off or diverted. Furthermore, air mass flows (30) or engine flows can be additionally fed in, or fed out. In addition, dampers (1702) are suitable for controlling a variable flow for defined conditions, or for regulating cross-sections.

Objectives here can be:
Limitation in case of unstable compressor work
Limitation of mechanical loads,
limitation of thermal loads
Limitation of unstable combustion

With Mach number enlargement, the compression in the inlet can be increased, if necessary. The Mach number increase leads to higher compression of the inlet air mass flow (30). With higher Mach number, the geometry of the critical area of the nozzle can be enlarged. This leads to thermal and mechanical relief of the combustion chamber or adaptation in the engine duct (1001).

The figure is divided into a flow section in front of the flap (1701), the area of the flap (1702) with the flap and adjustment devices, and the flow section behind the flap (1703). The cross-sectional area behind the flap (1703) is widened to represent as large a control area as possible. This results in a delay of the flow for incompressible media.

With a reduced cross-section, the air mass flow (30) is accelerated to a permissible maximum value (1704). The maximum value (1704) is derived from the permissible mechanical and thermal loads on the flap (1702) and the remaining engine duct (1001). Depending on the engine duct (1001) downstream, the air mass flow (30) can, if necessary, expand again and take up the original cross-sectional area with losses. In an assumed neutral position (1705), there is no decisive change in the air mass flow (30). In the minimum position (1707) of the damper (1702), a maximum deceleration of the air mass flow (30) can also be aimed at if necessary.

In summary, flaps (1702) are basically and versatile for the mechanical control of engines, possible especially with flat contours. However, the use of flaps (1702) results in disadvantages and technical limitations. For example, moving parts are always a source of faults and susceptible to failure in terms of the stressed mechanics and seals. In addition, dampers (1702) are costly and have complex interdependencies. In addition, the effectiveness of flaps (1702) may be limited, as illustrated by FIG. 17. Downstream (1703), for example, expansion may occur again. Aerodynamic drag can also occur at flaps. It is frequently stated that the engine weight can increase disproportionately as a result of control, leading to inevitable performance losses for the missile or engine. For flaps (1702), appropriate hydraulics, motors, controls, bearings, locking if necessary, cooling if necessary, material strength, supply systems, sealing if necessary, maintenance, etc. are required. This results in costs and development effort. In any case, there is reason to further develop the geometric control and, if possible, to make it more flexible. Ideally, moving parts such as flaps (1702) should not be used directly in the engine flow.

In this respect, in comparison, a continuing trend in the creation of engineering structures is, for example, the use of fibers/nets/textiles made of steel, carbon and plastics, respectively. Possibly, based on progressive development, this holds further serious potential for aerospace regulation.

FIG. 18 sketches a mechanical control system for an intermediate body. No claims for protection are made with this indicative sketch.

Compared with FIGS. 4 and 5, a more refined inlet system with higher compression is required for ramjet engines at higher approach velocities (e.g. approx. Mach 2). According to the state of the art, this is handled with intermediate bodies (1826) in the inlet.

FIG. 18 shows a kinematic system for a swing-open intermediate body (1826) of a flat inlet. The design variant has been chosen to limit flow losses with the greatest possible permeability in the minimum position.

Various flaps are shown which can form an intermediate body (1826) when adjusted accordingly. For this purpose, the flaps (1821, 1822, 1825) are shown retracted in order to limit the flow resistance in the retracted state, e.g. at low inflow velocity of the air mass flow (30). A deflector (1820) is provided in front of the flaps (1821) to prevent turbulence, thermal/mechanical loads and flow through. This is as close as possible to a subsonic ramjet as shown in FIG. 4.

At higher inflow velocities of the air mass flow (30), the forward flaps (1821) swing open and are fixed by holding torques, actuating mechanisms, etc. The middle flaps (1822) are then extended to the maximum position. These flaps (1822) are shaped in such a way that they have an adapted and angled upwind side in order to map the intermediate body in the best possible way. The end flap (1825) prevents flow around or unstable conditions, e.g. at higher combustion chamber pressures. For relief against combustion chamber pressures, the end flap (1825) is notched for a retaining rod or retaining points (1824). Simplified, a minimum and a maximum position is possible with this shape.

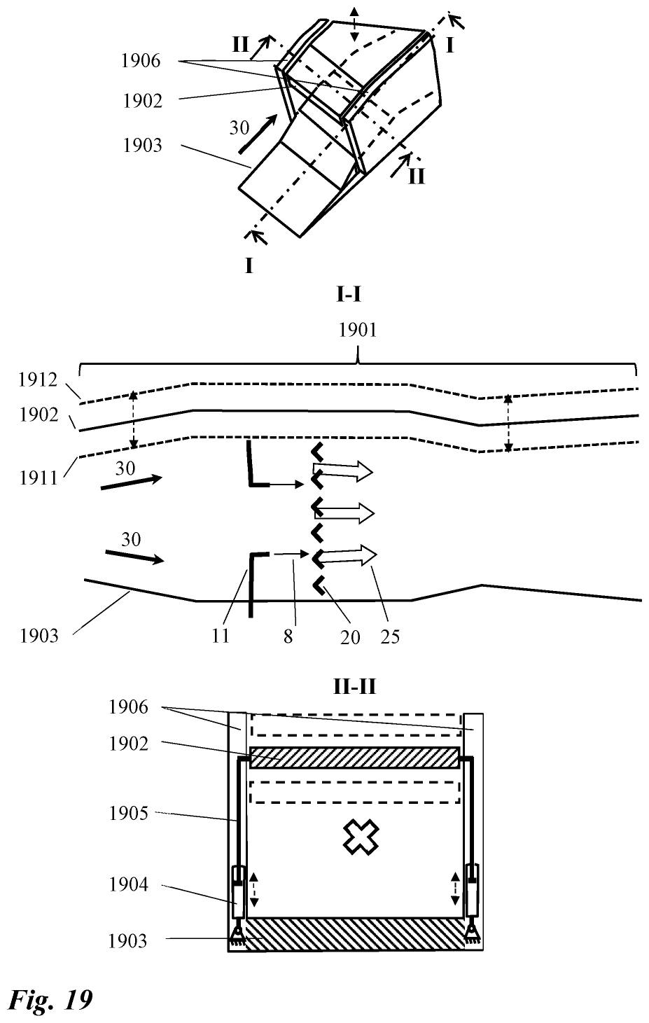

FIG. 19 shows several views of a special subsonic ramjet. Compared with the design variant in FIG. 4, a subsonic ramjet with a flat inlet and a movable or flexible cross-section is shown. A movable combustion chamber wall (1902) is arranged on two rigid side walls (1906). In this embodiment, the opposite side of the combustion chamber is rigid (1903). Alternatively, the opposite combustion chamber wall (1903) can also be displaced. The displaceable combustion chamber wall (1902) is movable by means of hydraulics (1904), deflectors (1905). In this embodiment, the movable combustion chamber wall (1902) is undivided along the entire engine duct (1901) with one degree of freedom transverse to the air mass flow (30).

By narrowing the total cross-section to a minimum (1911), for example, the initially low and slow air mass flow (30) can be converted at increased speed in the flexible engine duct (1901). At higher speeds, maximizing the engine cross-section (1912) is advantageous, e.g. to relieve the inlet.

A separate enclosure or outer nacelle is possible, but not considered in this example. In accordance with FIG. 4, an intermediate body has also been omitted.

For simplification, the internals in the engine duct (1901) such as injection (11) for fuel (8), flame holder (20) for combustion (25) are designed as rigid. Alternatively, some of the internals can also be attached to the flexible combustion chamber wall.

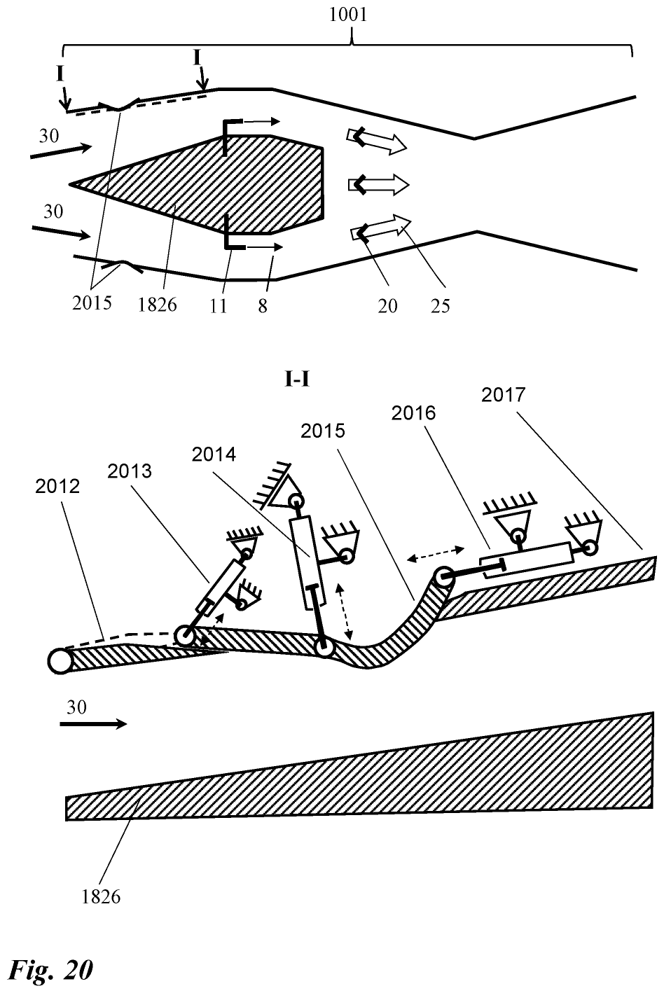

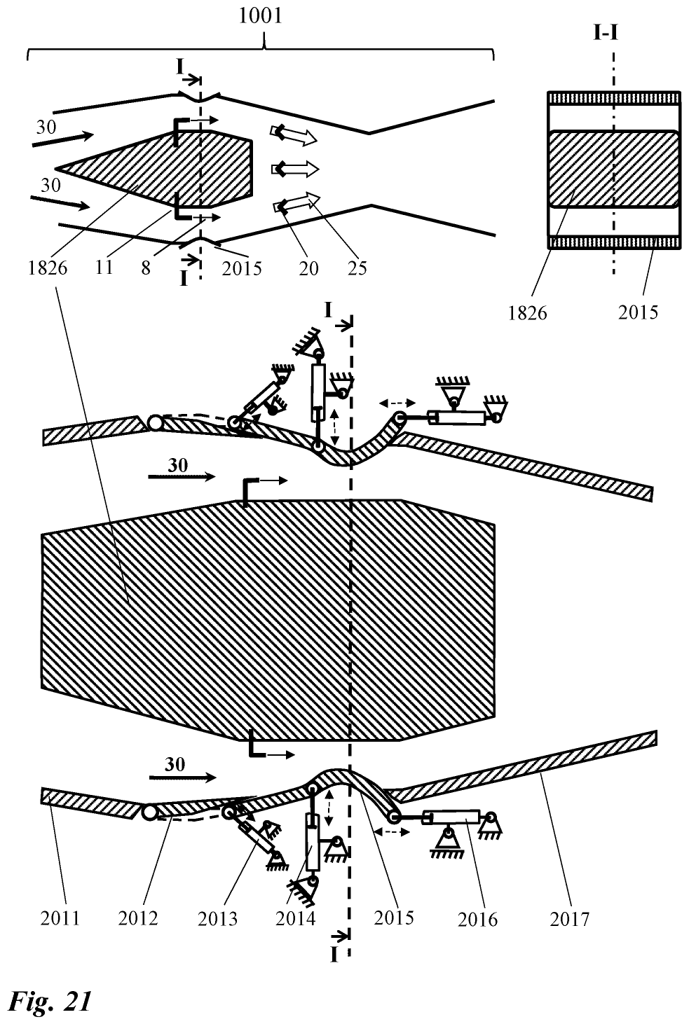

FIG. 20 shows a mechanically activated control system. This control system also has the potential to influence the engine duct volumetrically. This illustration is not intended to claim intellectual property rights, but to illustrate relevant possibilities and complexities.

In this embodiment, a combination of mechanical components, such as hydraulic systems, bearings, etc., and possibly marginal flaps (2012) with a body is shown. The body (2015) can deform the volume/engine duct (1001). Ideally, it should be used with flat inlets, or engine ducts (1001). This principle is referred to below as a volumetric system. In this embodiment, in particular, a combination of mechanical-volumetric control is illustrated with an advantageous marginal design.

In the embodiment variant, mats (2015) made of fibers of a ductile metal (e.g. copper/nickel/steel) are shown. These mats (2015) can also be designed as a closed cushion, or bead. Alternatively, a design with other materials such as ceramic fibers is possible. The bending stiffness of the mat (2015) can be adjusted by layers of mats and mesh mats with different running directions. Furthermore, the mats (2015) can additionally be attached to movable retaining bars (e.g. on both sides of the mats).

The cross-section for the air mass flow (30) is narrowed by bending and pressure, or “squeezing” on presses/hydraulics (2014). At the side of the mat (2015), upstream, a flap (2012) and inclined cylinders (2013) are shown. Through this device, the shape and tension of the mat (2015) can be better adjusted and made uniform. To limit stresses, if necessary, can also be shifted in several sub-segments. For cooling, if necessary, expanded compressed air, or an attached cooling circuit can serve. Downstream with (2016) another hydraulic system is attached to regulate the tightness and shape also at different loads/temperatures. Upstream of the control system, there is a wall piece (2011) with an edge to fit the system optimally into the engine duct (1001). After the system, downstream, the thruster wall (2017) is also designed in an analogous manner to be connectable and rounded.

In order to achieve the highest possible load-bearing capacity with the best possible flexibility and the lowest possible weight, a composite structure consisting of a sealing layer, a force-conducting intermediate layer (e.g. meshes, honeycombs, rings) and, if necessary, a counter-layer is possible. Ring structures have been proven, for example, in historical chain mail as flexible protective clothing.

The surface of the mat (2015) can be designed to favor flow, e.g. with recesses, or small riblets, dimples. This arrangement has only a low flow resistance. However, the complexity of the design variant is very high.

For the sake of good order, intermediate body (1826), injection (11), for fuel (8), flame holder or igniter (20) for combustion (25) are shown.

FIG. 21 shows a mechanically activated control system with volumetric elements in the mixing section. This illustration is not intended to claim property rights, but to illustrate the possibilities and complexities.

In contrast to FIG. 20, in this embodiment the adjusting device in the mixing area is provided on the outer wall of the engine duct (1001). Alternatively, an opposite arrangement on the intermediate body (1826) is possible.

With appropriate cooling, or short use, it is also possible to use it in the combustion chamber area.

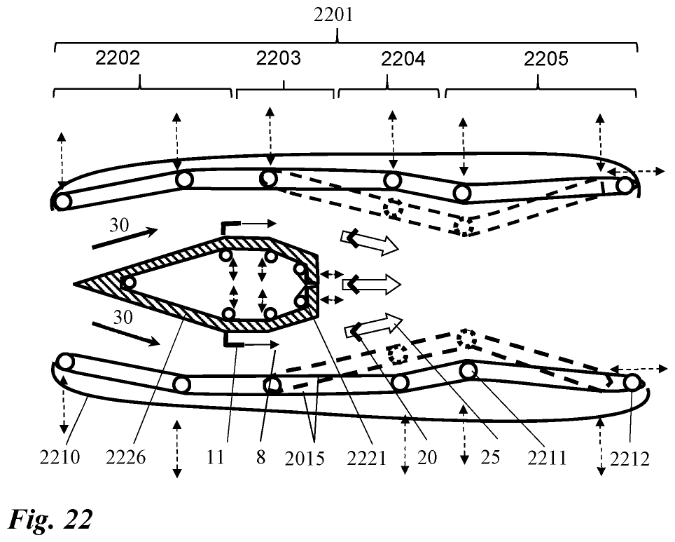

A sketched longitudinal section of a ramjet is included in FIG. 22. The ramjet has a flexible mat over the entire engine duct. This illustration is not intended to claim intellectual property rights, but to illustrate the possibilities and complexities.

Analogous to the previous embodiments, a flat engine duct (2201) is shown. The side walls are fixed and arranged around the engine duct (2201). An outer nacelle (2210) is provided.

Compared to FIG. 21, in this embodiment a flexible mat (2015) is present over the entire area of the flexible engine duct (2201).

In order to adapt the inlet (2202), mixing area (2203), combustion chamber (2204), nozzle (2205) accordingly in a flexible manner, a mat (2015), fiber-reinforced mesh, armored chains (chain mail), metal strips, etc. can be used, for example.

The mat (2015) has layers of finer fibers for sealing and thicker fibers for load transfer, or alternatively high-strength, fine and flexible fiber structures. The mat (2015) is force-fitted to rods (2211) on both sides or, as in this embodiment, the mat (2015) wraps around the retaining rods (2211). At the end, a special retaining rod (2212) can be moved along the longitudinal axis of the engine duct (2201) for retensioning. The rods (2211, 2212) are movably attached to the fixed side walls of the engine duct (2201).

In the embodiment, the intermediate body (2226) is also designed to be movable.

This arrangement enables optimum combustion (25) at the flame holders (20).

The relatively short time until burnout at an altitude of approx. max. 100,000 ft of max. 90 s has a relieving effect on the heat balance of the engine (2201). The thermal inertia of the material can also be utilized here. In addition, flexible hollow fibers can be flushed with cooling liquid, or e.g. compressed air can be expanded between outer nacelles (2210) and mat (2015).

The intermediate body (2226) is provided with a separate reinforced tensioning device (2221).

This form of control is according to the invention by movable mats and can be limited to individual areas. A mechanical solution with volumetric design potential is provided.

FIG. 23 shows a longitudinal section of a volumetric (fluidic) control system according to the invention.

Hardships and complications that usually speak against the use of comprehensive control in engine systems are mainly:
the additional complexity,
the additional weight,
susceptibility to faults.

In this example, a simplified control system based on elements of inflatable, press-on cushions (ideally pneumatic) is presented. Such cushions can be designed to be powerful and resilient. A recent and concise application is the use of heavy-duty cushions in Austrian and German tunnel construction underground in a limited turning area. This was the case in the “Stuttgart 21” rail project. In 2020, up to approx. 1,000 t heavy segments of a powerful tunnel boring machine were moved underground in a so-called “Wendekaverne” (turning cavern) and reliably turned in a very small space. Sealing pads are also used in other engineering applications, e.g. for sewers.

The heavy-duty cushions (2302) allow an effective counterpressure to be built up against the flexible thruster duct (2301). This also allows the dissipation of stresses, bends, etc. Ideally, this eliminates the need for further retaining systems, rods, mating parts, etc. This reduces effort, weight and costs.

In principle, only an outer nacelle (2210) or supports, heavy-duty cushions (2302), composite structure if required, and a flexible cover layer (2303) are necessary. Cables and fibers in the flexible cover layer (2303) allow the transfer of tensile and shear forces in the tensioned state, or composite. Tension cables, for example, are used for long bridges in lightweight construction. Safety nets and meshes are used to protect against rockfall and avalanches.

The heavy-duty cushions (2302) in this example are used pneumatically. If necessary, a multilayer and parallel structure of the heavy-duty cushions can be selected.

A flexible cover layer (2323) with high post-tensioning is installed in the area of the flexible intermediate body (2326). This ensures that the intermediate body (2326) with the heavy-duty cushions (2322) contained therein is minimized for low inflow velocities of the air mass flow (30). Optionally, the heavy duty cushions (2302, 2322) are provided in single or multiple layers, or divided along the cross-section. The intermediate body (2326) can also be created polygonal, e.g. rhombic, in cross-section to approximate a highly effective annular combustion chamber.

For reasons of weight and performance, the heavy-duty cushions (2302, 2322) are actuated pneumatically, e.g. by compressed air, or by a flow of air (30). A hydraulic version is possible, e.g. by means of pumping liquids, possibly storable fuels (8) (e.g. kerosene). However, this is thermally more demanding, e.g., for longer operating times. In addition, if pneumatic cushions (2302, 2322) are used, they can be depressurized, e.g. via pressure relief valves, when the internal pressure increases due to heating. The relaxed working fluid has a cooling effect.

Alternatively, a combination of cushions (e.g. for the inlet) and mechanical systems, or fixed sections, is also possible (e.g. in the combustion chamber).

FIG. 24 shows a longitudinal section of a ramjet engine.

Compared with the version shown in FIG. 23, this simplified version of the engine duct (2401) does without an intermediate body. In the inlet (2402) and the mixing area (2403), the flexible mat (2302) is deformed more strongly, if necessary, to achieve suitable compressions. Between the mixing area (2403) and the combustion chamber (2404), it is more inclined to maximize the allowable combustion chamber pressure by increasing the cross-section of the combustion chamber (2404). If necessary, the nozzle (2405) can be raised to relieve the combustion chamber (2404) thermally.

Adaptive expansion of the engine cross section in the area of the combustion chamber (2404) can provide additional thermal relief for the inlet. Alternatively, a combination with an intermediate body may be advantageous for low inflow velocities. For example, for large air mass flows (30) with high density and low inflow velocity, this can contribute to sufficient combustion in a startup phase. To increase the thermodynamic efficiency of cyclic processes, high pressures are generally advantageous.

If necessary, combustion pressures can be increased by means of a Treiber Concept for catalytic combustion (patent applications DE 10 2021 000 701.8 and DE 10 2021 001 272.0). Contactless ignition via electromagnetic waves (e.g. microwaves) is also valuable for reducing pressure losses in the combustion chamber, as internals such as flame holders can be reduced (patent application DE 10 2021 001 272.0).

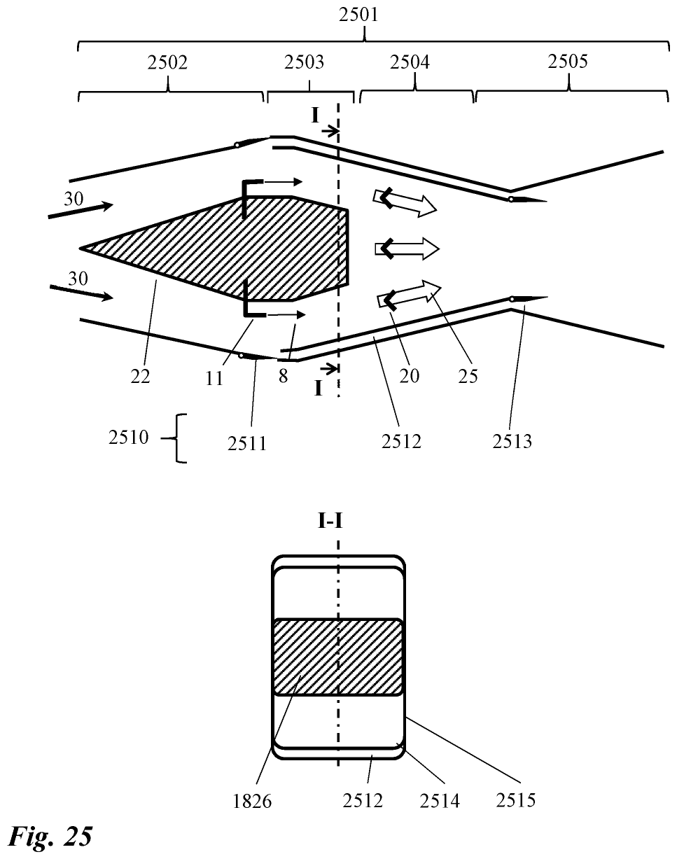

FIG. 25 is a longitudinal section of a ramjet. In this embodiment, a boundary layer suction system (2510) is shown. The boundary layer can contribute to blocking of the inlet (2502) in unfavorable situations, e.g. at high combustion chamber pressures. The resulting scouring of the inlet (2502), or engine duct (2501), is associated with a loss of thrust.

The boundary layer can lead to an “energy loss”, i.e. energy transfer across the system boundary of the thruster (2501). In order to aim for positive limits, the boundary layer is extracted after the inlet in the area of flaps (2511). The exhaust is led into a bypass (2512). To avoid losses of fuel (8), the area of the suction (2511) is placed upstream of the area of influence of the fuel injection (11). Alternatively, it is also possible to exhaust further upstream or to discharge by further opening the flaps (2511). A feed (2513) is provided via the bypass (2512) into the area of the nozzle (2505). Here, an afterburning of the proportional air mass flow (30) exhausted with the boundary layer can be aimed at. Technically advantageous is also a cooling of the combustion chamber walls and at the incision of the nozzle (2505) during continuous operation, or to save effort. The kinematics in the nozzle (2505) can also be influenced. To increase this effect, the bypass (2512) can be widened in the meantime. This principle is not fundamentally new and is derived from earlier turbine engines or precursors of turbofan engines.

In addition, the geometric influencing of the boundary layer is carried out analogously to the acceleration of the boundary layers in wind tunnel test rigs (with projecting bodies in front of measuring areas) also by means of cross-sectional narrowing (2514). In cross-section I-I, the side walls (2515) are shown tapering in the gusset area (2514). Due to the cross-sectional constriction (2514), acceleration occurs in approximately incompressible media according to the continuity equation. The energetically decisive boundary layer is reduced.

For the sake of good order, it is also possible to influence the boundary layer at the micro level as an alternative to the above-mentioned possibilities at the macro level. Riblets (sharkskin) or e.g. dimples can be used for this purpose (see e.g. patent specification DE 696 20 185 T2).

In addition, the boundary layer can also be removed by suction at the side walls (2515). If movable mats are used, this is the preferred variant. A gap can also be opened up or regulated by means of cushions (2302). Technical simplifications are aimed at here.

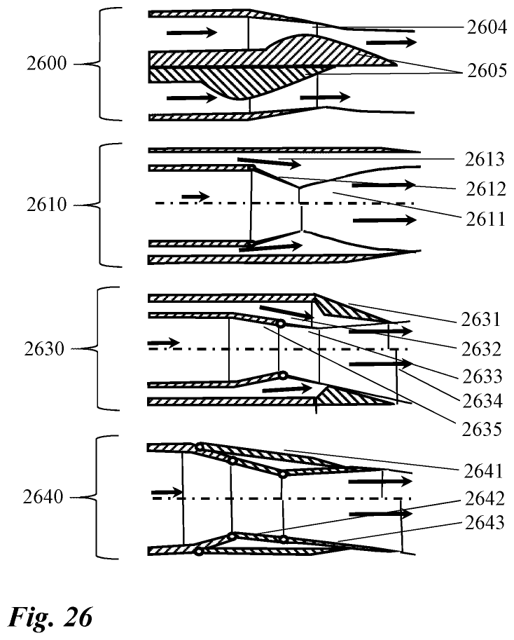

FIG. 26 shows sketches of various controlled nozzle concepts. This illustration is not intended to claim intellectual property rights, but to illustrate the possibilities and complexities.

In FIG. 26, according to [1], various selected design variants are shown for reference according to the state of the art for variable nozzles. Undesirable energy conversions in the engine and kinematic jet losses due to over/under expansion can lead to high efficiency losses of the expended engine power [2].

Nozzles with axially displaceable mushroom (2600) are considered, for example, in the patent specification US 2003 0154720 A1 for controllable Ramjets. This nozzle shape provides a relatively simple structure for control. The critical area (2604) can be increased or decreased by longitudinal displacement of the nozzle (2605). Relatively good characteristic values can be achieved with a relatively simple design. A disadvantage is generally the poor cooling of the central body.

Ejector nozzles with a rigid outer contour (2610) are common for early turbine engines. The gas flow (2611) flows inside the nozzle. The external ejector flow (2613) cools and is entrained by the gas flow under suction. The ejector flap (2612) has a partially self-regulating effect. This allows the critical area to be adjusted. Additional nozzles have been developed to improve the characteristic values (e.g. the thrust coefficient).

The ejector design with inner Laval nozzle (2630) has some additional elements. A Laval nozzle (2635) is installed for the inner gas flow (2634). For example, the outer aerodynamic flow can be improved with devices (2631). Dampers (2632) regulate the critical area, or distribution, of the outer ejector air flow (2632) and inner gas flow (2634).

Laval nozzles with two rows of segments (2640) represent another design. The two inner conical flow sections (2642) and (2643) consist of movable segments. By means of two surrounding belts of hydraulic cylinders (2641), different expansions or contractions can be exerted. This allows the critical area and the nozzle exit area to be continuously adjusted.

According to [10], the detachment zone in nozzles can be influenced, among other things, by adjusting the pressure of the combustion chamber. In patent application DE 10 2021 004 141.0, this is aimed at in terms of process, e.g. by using catalytic combustion (with variable loads).

FIG. 27 is an illustration with upstream flaps (2710) as a guidance system according to the invention. Further templates for this are manta rays. In this embodiment, auxiliary power systems (2720), or “boosters”, are arranged laterally for the first phase of rocket launch. In this embodiment, 3 boosters are attached to the lower stage (2710). Alternatively, an arrangement with, for example, 2 or 4, or more or fewer boosters is also possible. On the one hand, these auxiliary boosters (2720) use the aerodynamic flow around the rocket (2700), and on the other hand, these inflow flaps (2722) have surfaces for an additional inflow.

The ability to parallelize the operation of conventional engine systems of lower stage (2710) and boosters, or air-breathing engine systems (2721), means that the thrust of the various engines can be applied simultaneously, selectively and variably. In this way, for example, the variable inflow velocity, density and other parameters can be balanced in the best possible way. Other remaining parameters are e.g. temperature, viscosity etc.

The auxiliary power unit systems (2720) consist of 1 row of hinged leading edge flaps (2722). Alternatively, a design with more rows is also possible. As shown in FIG. 13, the approach flaps (2722) have an open passage (2724) in order to prevent scavenging of the incoming air mass flow (30) as far as possible and to reduce the aerodynamic resistance. In this example, the open passage (2724) is of fixed design, but can also be geometrically modified using heavy-duty cushions. The inflow flaps (2722) collect additional air mass flow (30) for inflow to the air-breathing engine systems (2721). The inflow flaps (2722) can be movably adjusted against the inflowing air mass flow (30), possibly using heavy-duty cushions, or pneumatic components. The upstream dampers (2722) form an inlet with the lower stage (2710), i.e. the upstream dampers (2722) are arranged on the outside. The air-breathing engine systems (2721) are each arranged in quadruplicate in an auxiliary thruster (2720) or “booster”. The air-breathing engine systems (2721) have flat inlets with intermediate bodies and flat engine ducts for maximum controllability.

Alternatively, a combination of a flat inlet with a concentric combustor is also possible, as shown for example in patent specification U.S. Pat. No. 6,786,040. Characteristic of this example is the short design of the auxiliary power units, or boosters (2720), in order to maximize aerodynamics and reduce costs, or save weight. The reduced weight is advantageous for landing by braking chute after burnout. Fuel is supplied from the lower stage (2710) or its tanks. The geometry of the air-breathing thrusters (2721) is flexible according to the concept of FIG. 23.

After separation of the auxiliary power systems or boosters (2720) at an altitude of about 100,000 ft or about 30 km, they are returned to the earth's surface by braking chute to enable reuse. Alternatively, a propulsive landing can be attempted via additional tanks.

The rocket is further accelerated by the lower stage (2710) with the conventional rocket engines. After its burnout, further acceleration is performed by the upper stage (2730) or, if necessary, the intermediate stage. The payload (2740) is accelerated into the corresponding orbit.

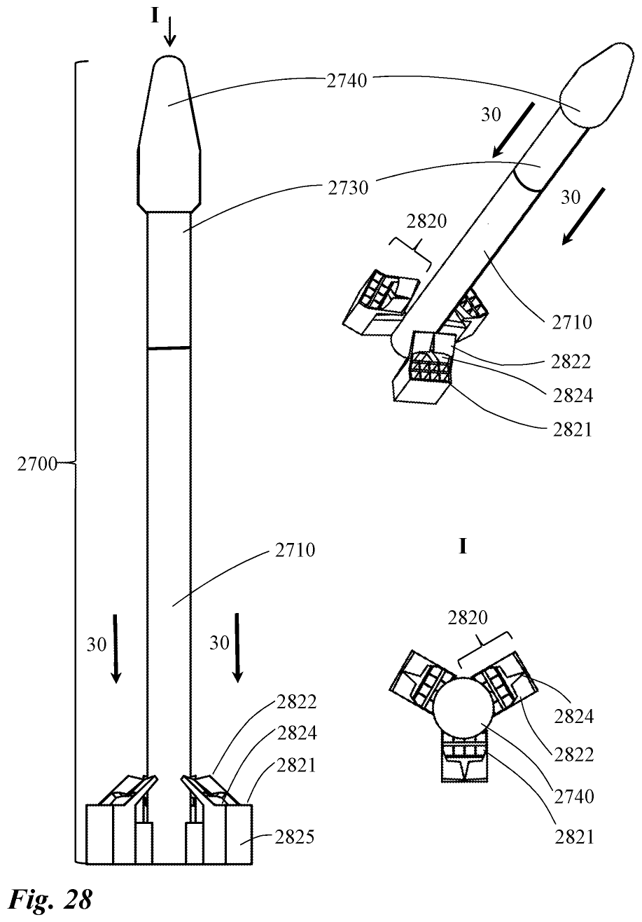

FIG. 28 is another illustration. Compared to FIG. 27, the auxiliary power systems (2820) are tapered toward the lower stage (2710) of the rocket (2700). The auxiliary power systems (2820) include air-breathing engine systems (2821), outer nacelles (2825), and inflow flaps (2822). The air intake flaps (2822) are arranged on the inside of the lower stage (2710), the air-breathing engine systems (2821) on the outside. Compared with FIG. 27, the outer nacelles (2825) of the auxiliary power units (2820) are also wider. This provides space for turbopumps, adjusting devices, possibly auxiliary tanks for propulsive landing etc. The free passage (2824) of the air-breathing engine systems (2821) lies rotated in the horizontal plane as a mirror image of FIG. 27.

This example is further approximated to FIG. 13 (manta ray). The result is an arrow shape, but with the “mouth”, or inlet, set back.

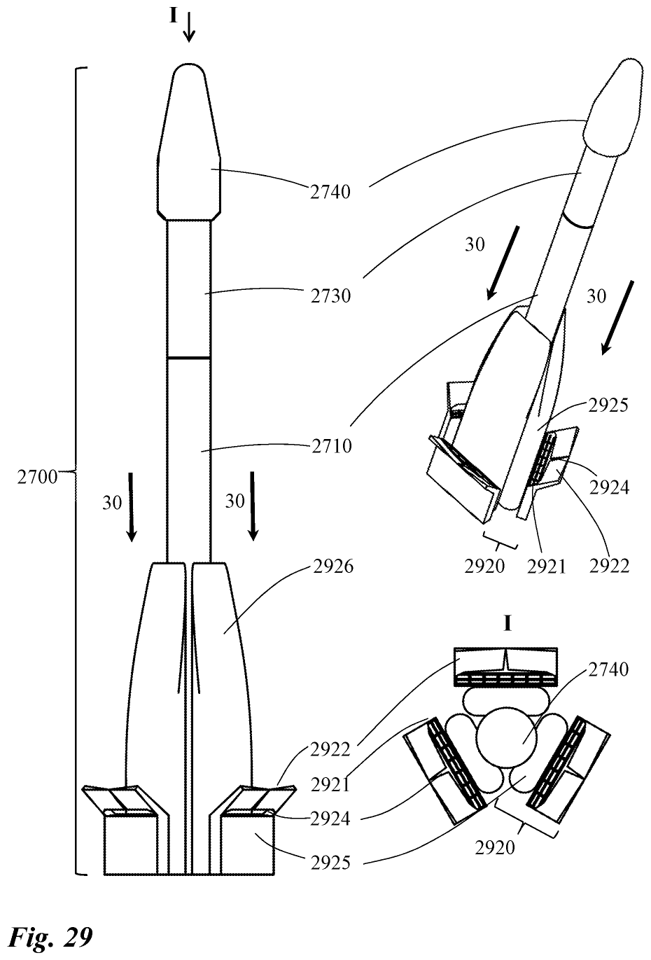

FIG. 29 shows another embodiment in an illustration.

Compared with the embodiments of FIGS. 27 and 28, in this embodiment the auxiliary power unit systems (2920) are equipped as independent systems including tanks and turbopumps. Accordingly, the auxiliary power unit systems (2920) are enlarged. This allows further optimization of the structural mass of the remaining lower stage (2710). As a result, the auxiliary power unit systems (2920) are equipped with an additional assembly (2926) in order to be able to install, for example, the tanks, turbopumps, etc. The additional assembly (2926) is shaped as an inlet with ramp on the upstream side. Attached to it are the outer nacelles of the auxiliary power units (2925).

As shown in FIG. 28, the outer nacelle of the auxiliary power unit systems (2925) contains the air-breathing power unit systems (2921), movable upstream flaps (2922) and diffuser (2924).

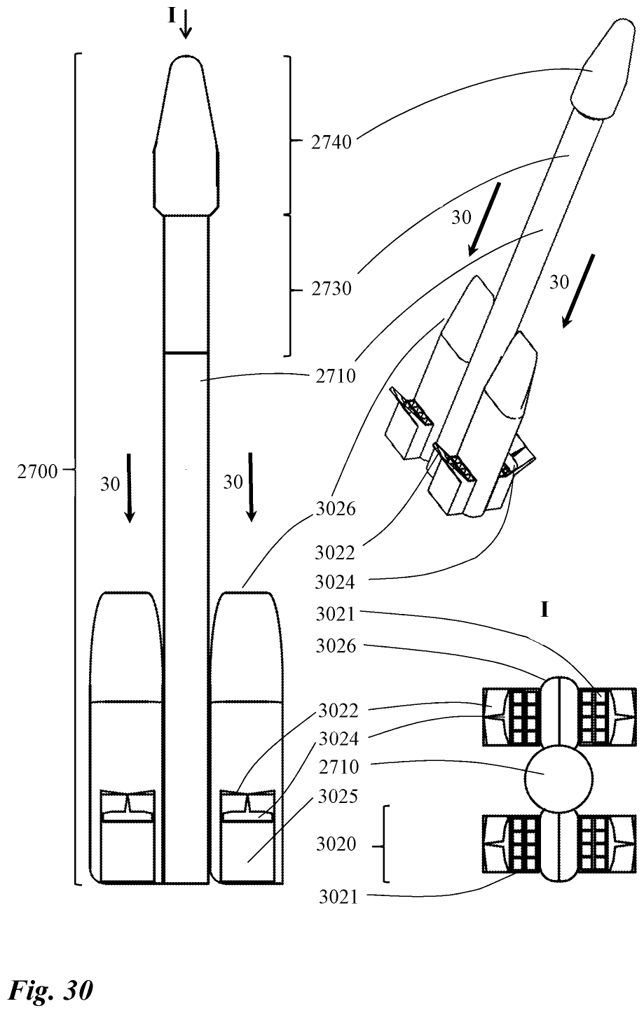

FIG. 30 shows a further illustration from several viewing directions.

Compared to FIG. 29, the auxiliary power unit systems (3020) are arranged on widened fins (3026) to feed the incoming air mass flow (30) into the air-breathing power unit systems (3021). A symmetrical system of two widened fins (3026) at the lower stage (2710) is shown. Alternatively, 3 or more corresponding fins are possible.

On both sides of the widened fins (3026) there are 4 air-breathing engine systems (3021) with intermediate bodies and flat inlets. Advancing inflow flaps (3022) with free space between them (3024) prevent the air from flowing around them as far as possible. The result is a tapered shape with maximum width at the engine inlets of the air-breathing engine systems (3021). The outer nacelles (3025) of the air-breathing engine systems (3021) are connected to the fuselage of the remaining auxiliary power units (3020) via side webs. Fuel tanks, turbopumps, etc. are located in these auxiliary power units (3020).

The rocket (2700) is launched with the lower stage (2710). By additionally feeding in an oxidizer, the air-breathing auxiliary power units (3020) are self-launching (e.g. patent specification DE 10 2021 000 530.9) and accelerate the rocket (2700) along with it. By increasing the incoming air mass flow (30), the thrust of the auxiliary power units (3020) increases. The additional feed of the oxidizer can be stopped at a certain velocity. In this embodiment, this is from about Mach 0.75. To increase the capability of the air-breathing engine systems (3021) for low-pressure inflow, the intermediate body is minimized, i.e. retracted. In addition, the additional inflow surfaces of the inflow flaps (3022) accelerate the air mass flow (30). As shown in FIG. 1, this can decisively increase the performance of the air-breathing engine systems (3021). With increasing inflow velocity, the air-breathing engine systems (3021) with flexible geometry are ramped up to form ramjets (see FIG. 5). This can be done mechanically or volumetrically by means of heavy-duty cushions (see FIG. 23).

Depending on the incoming air mass flow (30), the conventional engine systems of the lower stage (2710) may be switched off, varied in intensity, or re-ignited. In the case of reduced incident flow of the air mass flow (30), the additional feed of oxidizers can be restarted if necessary in order to utilize the decreasing air mass flow (30) as long as possible and to be able to use it energetically for effective acceleration.

To increase the controllability of the engines and their performance, reference is made to patent applications DE 10 2021 000 701.8, DE 10 2021 001 272.0, DE 10 2021 004 141.0. Variable loads of catalytic absorbers are fed into the engines (2721) and ignited/stimulated by electromagnetic waves (e.g. by microwaves).

Upon reaching an altitude of approximately 100,000 ft, or 30 km, the air-breathing auxiliary power units (3020) are disconnected. This altitude can alternatively be further increased at maximized orbital inclination with maximized speed and additional loads of catalysts to avoid flameout and pressure losses.

Subsequently, the rocket (2700) with lower stage (2710) and subsequent stages (2730) with the payload (2740) can be accelerated toward the target orbit.

It should be noted that the arrangement of a central two-stage rocket (2700) with payload and two lateral auxiliary power systems has a superficial similarity with a Falcon Heavy. However, key parameters for stage separation and type of propulsion systems are different from the Falcon Heavy.

In addition, a special separable missile can possibly be further developed from the basic shape of FIG. 30 by utilizing the fins for lift. The separable missile has flight characteristics with lift forces like an airplane. This would allow further air-breathing oblique takeoff, or horizontal flight. The added benefit of the Heber Concept is that the denser air layers can be exited early, avoiding adverse drag and overheating of the missile (2700). Also, gravity loss is minimized with vertical launches. This would be a Saenger Concept port option, which is particularly advantageous when using air-breathing supersonic combustion.

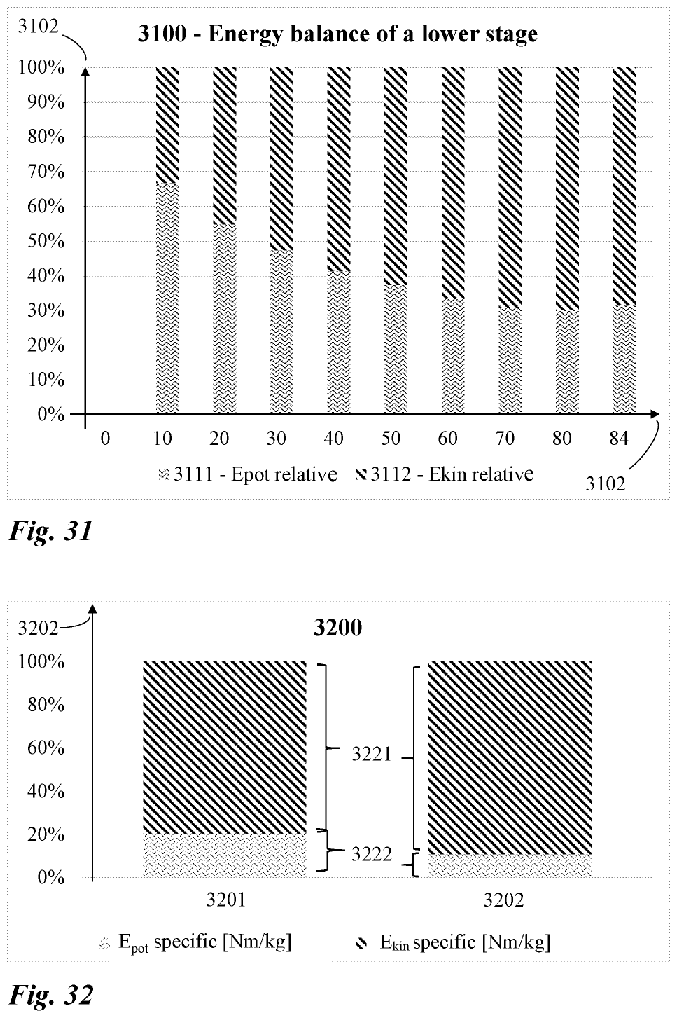

A significant effect and relevance for the Heber Concept is the additional inflow, i.e. acceleration and possible further compression, in this technically demanding but particularly interesting limit range. Reference has already been made to the advantages of designing conventional rocket engines of the lower stage (2710) for altitude ranges with low pressure (solution of the task, engine systems). The Heber Concept explicitly does not preclude subsequent energetically oriented acceleration flights. At high altitudes, the remaining mass of the rocket causes a significantly higher energy conversion in the velocity dimension than at altitude. Further explanations follow in FIG. 31 and FIG. 32. FIG. 31 presents a simple bar graph of potential and kinetic energy components.

This reflects the energy in height in the gravity system of the earth and velocity at rocket launch.

In (3100), a simplified energy balance is based on the parameters of the International Standard Atmosphere (ISA), or on the example of a Falcon 9 rocket launch. On the horizontal axis (3101) are bars for altitudes in [km] and on the vertical axis (3102) the fractions in [%].

The total energy of the instantaneous rocket mass is considered simplified from proportions [%] of potential energy (3111) and kinetic energy (3112) along the altitude. Potential energy is balanced as the product of mass times acceleration due to gravity times altitude (“m*g*h”) and kinetic energy is balanced as the product of half the mass times the square of the velocity (“1/2*m*v²”). Above about 100,000 ft, or 30 km altitude, the power of the engines is predominantly converted to kinetic energy. The energy conversion in the velocity dimension is roughly twice as extensive.

FIG. 32 shows another bar chart with 2 freely selected states of velocity and altitude. With (3200) a diagram is shown that represents the total energy divided into potential energy and kinetic energy. The two states are chosen from FIG. 2 and do not result from a typical rocket launch! Therefore, conclusions cannot be drawn without further ado.

Limit values for air-breathing engine systems according to the current state of the art are shown on the horizontal axis (FIG. 2). For the first state (3201), a speed of about Mach 5 can be derived for an altitude of about 100,000 ft, and for the second state (3202), a speed of about Mach 8 can be derived at about 131,000 ft. For masses of 1 kg, the potential energy in [Nm/kg] is shown by (3222) and the kinetic energy by (3221).

On the vertical axis, the energy fractions are shown in [%] (3202). The kinetic energy increases from state 1 to 2 by more than 2,000,000 Nm/kg, whereas the potential energy “only” increases by approx. <100,000 Nm/kg. The reason for the one order of magnitude different increase is the input of the velocity squared (Epot=1/2mv²). This means that for further energy conversion, a development of air-breathing engine systems for high altitudes and velocities is technologically particularly valuable. High altitudes cause less frictional heat with reduced atmospheric density, for example. Reference is made to the other patent applications DE 10 2021 000 701.8, DE 10 2021 001 272.0 and DE 10 2021 004 141.0.

According to FIG. 31, this is not directly transferable to a rocket launch. It is merely intended to illustrate a possible energetic effect at higher altitudes with suitable air-breathing engine systems. This can be realized, for example, with an additional air-breathing stage.

This effect is less interesting for lower speeds/altitudes and, on the basis of the explanations in FIG. 30 and FIG. 31, may lead to disproportionate disadvantages due to additional air friction and possible further losses.

What is described herein are specific examples of possible variations on the same invention and are not intended in a limiting way. The invention can be practiced using other variations not specifically described above.

What is claimed is:

1. A system for vertical or inclined take-offs of air-breathing engine systems comprising: an additional guidance system for the air-breathing engine system, which can selectively supply additional inflowing atmosphere or air.

2. An apparatus according to claim 1 comprising:
A control system capable of selectively supplying the additional incoming atmosphere in a variable manner to the air-breathing engine system.

3. A method according to claim 1 or 2
wherein the additional inflowing atmosphere, or air for at least one air-breathing engine system can be supplied by thrust, from at least one of: a conventional rocket engine system, an air-breathing engine system.

4. A method according to claim 1 or 3
wherein the additional incoming atmosphere, or air, is supplied by the thrust of the air-breathing engine system for at least one air-breathing engine system via the control system under the control of the control system.

5. A method according to claim 1 or 2
wherein a bypass or stall of the additional incoming atmosphere or air at the air-breathing engine system is specifically prevented by the control system and varied by the control system.

6. A guidance system according to claim 1 comprising:
At least one of the following: Culverts, bypasses, exhaust devices, open spaces, mass flow nodes.

7. A guidance system according to claim 1 consisting of:
at least temporarily and at least technically in part, at least one of the following: flexible textiles, nets, ropes.

8. A method according to claim 1
In which the air-breathing engine system is operated at least in part for launch purposes or to assist in operation with additional movable injection systems of an entrained oxidizer.

9. A system according to claim 1 comprising:
At least one of the following systems in a separable embodiment: air-breathing engine system, guidance system, control system.

10. A system comprising:
Volumetric base structure pneumatic or hydraulic press-on body and flexible deck structure as variable or partially variable in shape or position in at least one of the following systems: air-breathing thruster system, guidance system, control system.
